(19) United States
(12) Patent Application Publication
(10) Pub. No.: US 2026/0167117 A1
(43) Pub. Date: Jun. 18, 2026

(54) CONNECTOR

(71) Applicant: Liam Lafferty, Oseola, WI (US)

(72) Inventor: Liam Lafferty, Oseola, WI (US)

(21) Appl. No.: 19/368,586

(22) Filed: Oct. 24, 2025

Related U.S. Application Data
(60) Provisional application No. 63/713,702, filed on Oct. 30, 2024.

(51) Int. Cl. B60R 11/00

(52) U.S. Cl. CPC B60R 11/00; B60R 2011/0052; B60R 2011/0085

(57) ABSTRACT

An accessory attachment assembly comprises an attachment panel, an accessory, and a connector. The connector comprises a locking plate and a backing plate. The locking plate is arranged at a first side of the accessory and the backing plate is arranged at a second side of the accessory. The connector is rotatably adjustable to cause the accessory to be moved between a locked position and an unlocked position with respect to the attachment panel.

### CROSS-REFERENCE TO RELATED APPLICATION

This application claims the benefit of provisional application Ser. No. 63/713,702 titled “CONNECTOR,” filed Oct. 30, 2024, which is incorporated by reference in its entirety, herein.

### BACKGROUND

Attaching equipment to off-road vehicles can be important for enhancing their functionality, enabling them to perform a variety of tasks in challenging terrains. Off-road vehicles are commonly used in agriculture, forestry, construction, military operations, and recreational activities. Methods for attaching equipment to such vehicles vary based on the vehicle type and the specific use case.

### SUMMARY

In general terms, this disclosure is directed to a connector assembly. In some embodiments, and by non-limiting example, a connector assembly comprises a locking plate comprising a plate portion with a first side and a second side. The locking plate further comprises an inner ring portion, the inner ring portion extends from the locking plate. The inner ring portion comprises a sharp hard edge, a rounded soft edge, a projection, a first recess, and a central hole. The connector assembly further comprises a backing plate comprising a plate portion with a central hole extending through the plate portion, and a first elevation extending from the plate portion.

Another aspect of the disclosure is directed to an accessory attachment assembly comprising an attachment panel, an accessory, and a connector, the connector comprises a locking plate and a backing plate. The locking plate is arranged at a first side of the accessory and the backing plate is arranged at a second side of the accessory, the connector is rotatably adjustable to cause the accessory to be moved between a locked position and an unlocked position with respect to the attachment panel.

An additional aspect of the disclosure is directed to a connector assembly comprising a locking plate comprising an inner ring portion. The inner ring portion extends from the locking plate and further includes one or more sharp hard edges, one or more rounded soft edges, one or more sides between the one or more sharp hard edges and the one or more soft edges that define an outer portion of the inner ring portion, one or more projections within the inner ring portion, a first recess, and a central hole. The connector assembly further comprises a backing plate including a first plate portion with a central hole extending through the first plate portion and a first elevation extending from the first plate portion. The connector assembly further comprises a release plate comprising a second plate portion with a central hole extending through the second plate portion, a second elevation extending from the plate portion, a release lever with a protrusion, and a second recess. The release lever is configured to insert the protrusion into an aperture to lock the release plate and locking plate in a locked position and further configured to retract the protrusion from the aperture to release the release plate and the locking plate from the locked position. The first elevation of the backing plate extends into the second recess of the release plate, and the second elevation extends into the first recess of the locking plate.

### BRIEF DESCRIPTION OF THE DRAWINGS

FIG. 1 is an isometric view of an example attachment panel and an accessory connected to a connector.

FIG. 2 is an isometric view of the accessory and the connector of FIG. 1.

FIG. 3 is an isometric view of the connector of FIG. 1, containing a locking apparatus and a backing plate.

FIG. 4 is a front view of the connector of FIG. 3.

FIG. 5 is a back view of the connector of FIG. 3.

FIG. 6 is a right side view of the connector of FIG. 3.

FIG. 7 is a left side view of the connector of FIG. 3.

FIG. 8 is a top view of the connector of FIG. 3.

FIG. 9 is a bottom view of the connector of FIG. 3.

FIG. 10 is an isometric view of an example locking plate of the connector of FIG. 3.

FIG. 11 is a front view of the locking plate of FIG. 10.

FIG. 12 is a back view of the locking plate of FIG. 10.

FIG. 13 is a right side view of the locking plate of FIG. 10.

FIG. 14 is a left side view of the locking plate of FIG. 10.

FIG. 15 is a top view of the locking plate of FIG. 10.

FIG. 16 is a bottom view of the locking plate of FIG. 10.

FIG. 17 is an isometric view of an example backing plate of the connector of FIG. 3.

FIG. 18 is a front view of the backing plate of FIG. 17.

FIG. 19 is a back view of the backing plate of FIG. 17.

FIG. 20 is a right side view of the backing plate of FIG. 17.

FIG. 21 is a left side view of the backing plate of FIG. 17.

FIG. 22 is a top view of the backing plate of FIG. 17.

FIG. 23 is a bottom view of the backing plate of FIG. 17.

FIG. 24 is an isometric view of the accessory of FIG. 1 without the connector.

FIG. 25 is an isometric view of the attachment panel of FIG. 1 without the accessory or the connector.

FIG. 26 is an isometric view of the attachment panel and the accessory attached to each other by the connector of FIG. 1.

FIG. 27 is an isometric view of the connector attached to the attachment panel of FIG. 1.

FIG. 28 is another isometric view of the attachment panel and the accessory attached to each other by the connector of FIG. 1.

FIG. 29 is an isometric view of another connector according to the principles of the present disclosure, containing a locking apparatus and a backing plate.

FIG. 30 is a front view of the connector of FIG. 29.

FIG. 31 is a back view of the connector of FIG. 29.

FIG. 32 is a right side view of the connector of FIG. 29.

FIG. 33 is a left side view of the connector of FIG. 29.

FIG. 34 is a top view of the connector of FIG. 29.

FIG. 35 is a bottom view of the connector of FIG. 29.

FIG. 36 is an isometric view of an example locking plate of the connector of FIG. 29.

FIG. 37 is a front view of the locking plate of FIG. 36.

FIG. 38 is a back view of the locking plate of FIG. 36.

FIG. 39 is a right side view of the locking plate of FIG. 36.

FIG. 40 is a left side view of the locking plate of FIG. 36.

FIG. 41 is a top view of the locking plate of FIG. 36.

FIG. 42 is a bottom view of the locking plate of FIG. 36.

FIG. 43 is an isometric view of an example backing plate of the connector of FIG. 29.

FIG. 44 is a front view of the backing plate of FIG. 43.

FIG. 45 is a back view of the backing plate of FIG. 43.

FIG. 46 is a right side view of the backing plate of FIG. 43.

FIG. 47 is a left side view of the backing plate of FIG. 43.

FIG. 48 is a top view of the backing plate of FIG. 43.

FIG. 49 is a bottom view of the backing plate of FIG. 43.

FIG. 50 is an isometric view of an additional example connector with an example release lever.

FIG. 51 is a front view of the connector of FIG. 50.

FIG. 52 is a back view of the connector of FIG. 50.

FIG. 53 is a right side view of the connector of FIG. 50.

FIG. 54 is a left side view of the connector of FIG. 50.

FIG. 55 is an isometric view of the example release lever of the connector of FIG. 50.

FIG. 56 is a front view of the release lever of FIG. 55.

FIG. 57 is a back view of the release lever of FIG. 55.

FIG. 58 is a front view of an example backing plate of the connector of FIG. 50.

FIG. 59 is a back view of an example locking plate of the connector of FIG. 58.

FIG. 60 is an exploded view of the connector of FIG. 50.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

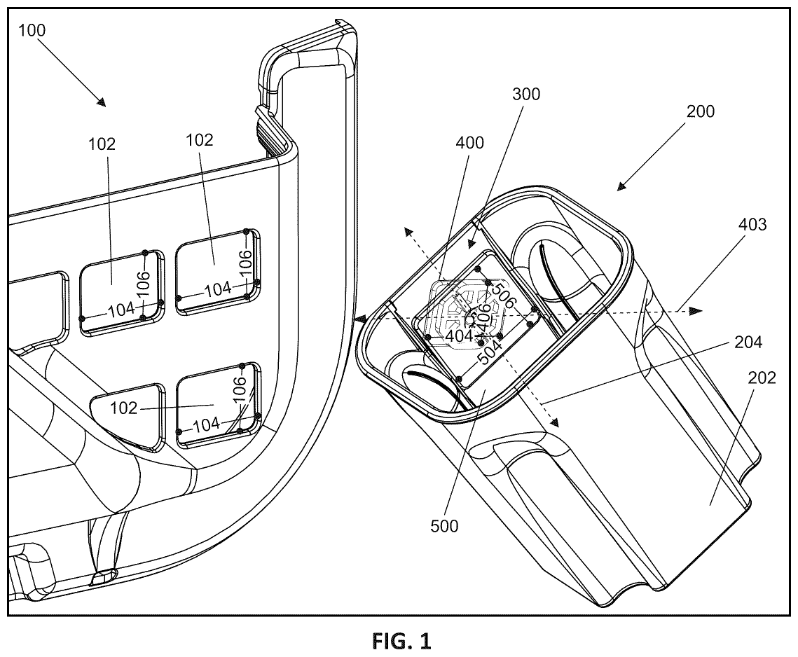

FIG. 1 is an isometric view of an attachment panel 100 and an accessory 200. The accessory 200 is connected to a connector 300. The connector 300 includes a locking plate 400 and a backing plate 500.

In some examples, the attachment panel 100 is a MOLLE (modular lightweight load-carrying equipment) compatible panel. The attachment panel 100 contains one or more openings 102. As shown in this embodiment, the openings 102 may have rounded corners. In other embodiments, some of or all the corners of the openings 102 may be unrounded. The openings 102 have an opening length 104 and a opening height 106. The opening length 104 of each opening 102 is the same. The opening height 106 of each opening 102 is the same.

As shown in the present embodiment, the accessory 200 has a shape that is suited for holding an item such as a cup. In other embodiments, the accessory 200 may have other shapes. The accessory 200 has an accessory axis 204. In some examples, the accessory axis 204 is a line that extends normally in both directions from a base 202. In some examples, the accessory axis 204 extends along a longitudinal axis of the accessory 200. In some examples, the accessory axis 204 is arranged vertically when the accessory 200 is secured to the attachment panel 100 in a locked position. In the present embodiment, the accessory 200 connects on one of its sides with the connector 300. In other embodiments, the accessory 200 may be capable of connecting with the connector 300 in one of multiple locations, or it may be capable of connective with multiple connectors 300.

The locking plate 400 has a locking length 404 and a locking height 406. The backing plate 500 has a backing length 504 and a backing height 506. The line along the locking length 404 and the line along the locking height 406 form a right angle. The line along the backing length 504 and the line along the backing height 506 form a right angle. The locking length 404 is less than or equal to the opening length 104. The locking height 406 is less than or equal to the opening height 106.

In some examples, the locking plate 400 comprises a locking plate major axis 403 that extends along the locking length 404. In some examples, the locking plate 400 is attached to the accessory at a skewed orientation, such that the locking plate major axis 403 is positioned at an angle with respect to the accessory axis 204. As used herein, “extending at an angle” means extending at an angle that is other than approximately zero degrees or approximately ninety degrees. In some examples, the angle is approximately forty-five degrees.

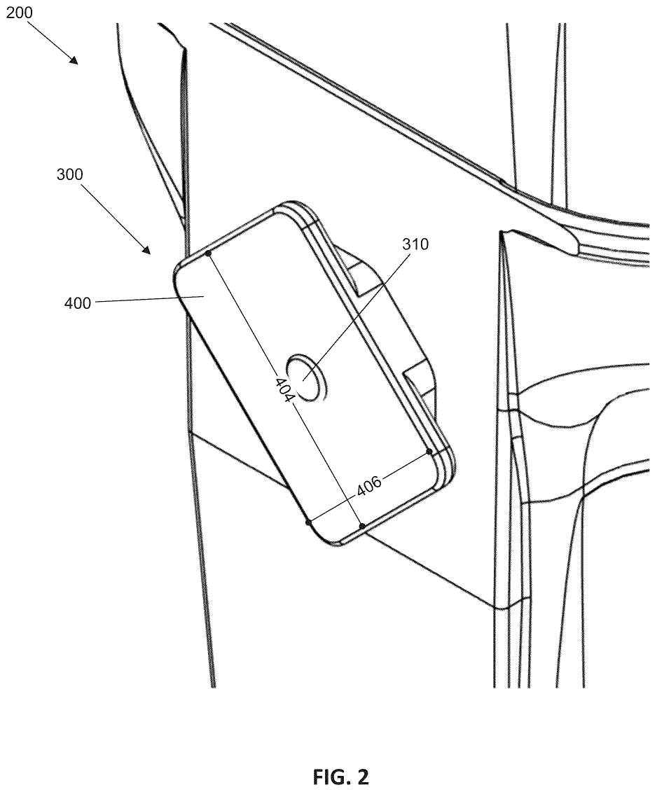

FIG. 2 is an isometric view of the accessory 200 and the locking plate 400. The locking plate 400 is attached to the rest of the connector 300, though only the locking plate 400 is visible. The connector 300 has a center hole 310 which is a circular cutout from the connector 300 by which it is attached to the accessory 200. The center hole 310 may be threaded so that it is suitable for attachment using a screw. In other cases, the center hole 310 is not threaded, such that a nut and a bolt are used to secure the locking plate 400. In other cases, other forms of fasteners are used to secure the locking plate to the backing plate 500, such as, for example, plastic snaps.

As shown in this embodiment, the center hole 310 is located at the geometric center of the locking plate 400. The center hole 310 extends through the entire connector 300 (i.e., through both the locking plate 400 and the backing plate 500) and the exterior of the accessory 200. By placing a screw through the center hole 310 from the inside of the accessory 200, the backing plate 500, the accessory 200, and the locking plate 400 are all held together.

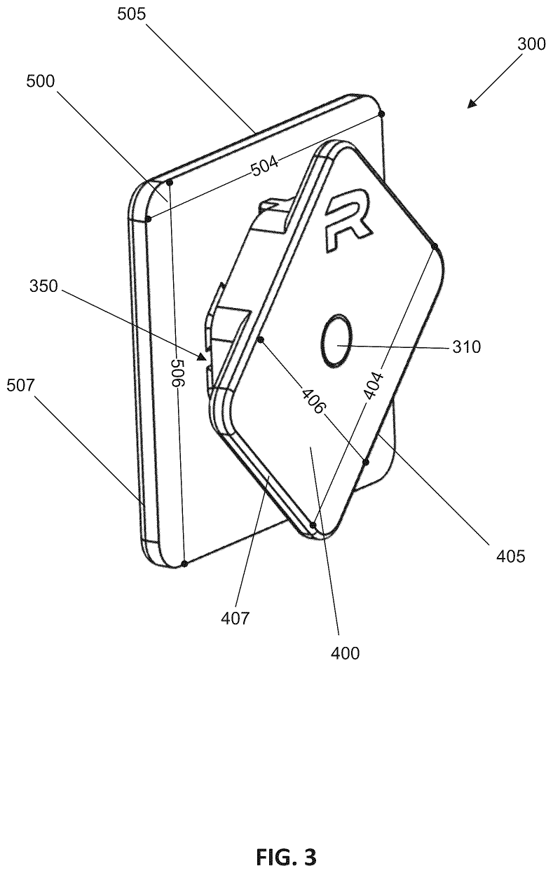

FIG. 3 is an isometric view of the connector 300, being comprised of the locking plate 400 and the backing plate 500. In this embodiment, the backing length 504 and the backing height 506 have the same value, meaning that the backing plate 500 has a square shape. The backing plate 500 also has rounded edges and corners. In other embodiments, the backing plate 500 may have other shapes and dimensions, and it may not have rounded edges or corners.

In some examples, the locking plate 400 includes a first side 405 that extends along the locking length 404 of the locking plate 400 and a second side 407 that extends along the locking height 406 of the locking plate 400. Likewise, the backing plate 500 includes a first side 505 that extends along the backing length 504 of the backing plate 500 and a second side 507 that extends along the backing height 506 of the backing plate 500.

There is a gap 350 between the backing plate 500 and the locking plate 400. This gap exists to allow the wall of the accessory 200 to fit between the backing plate 500 and the locking plate 400 when all three are attached.

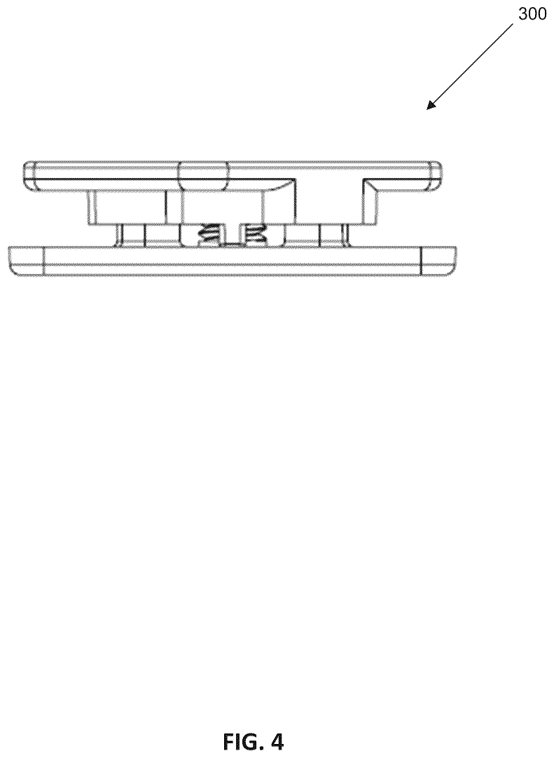

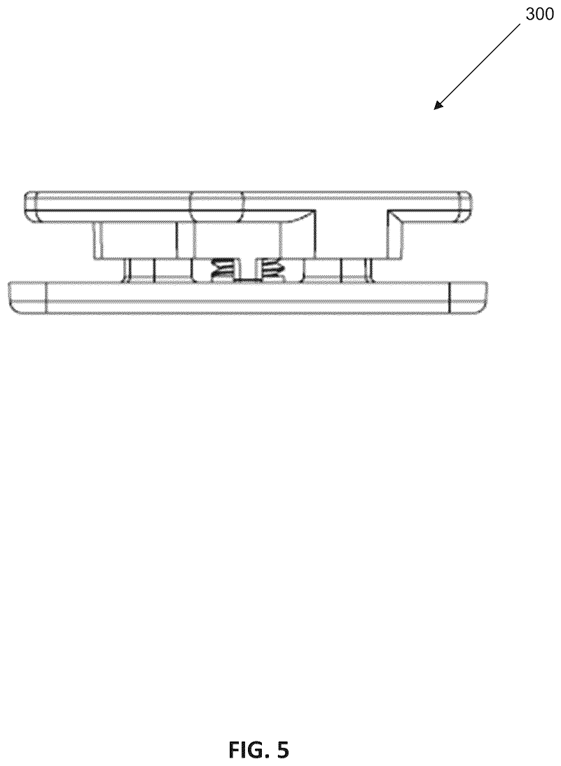

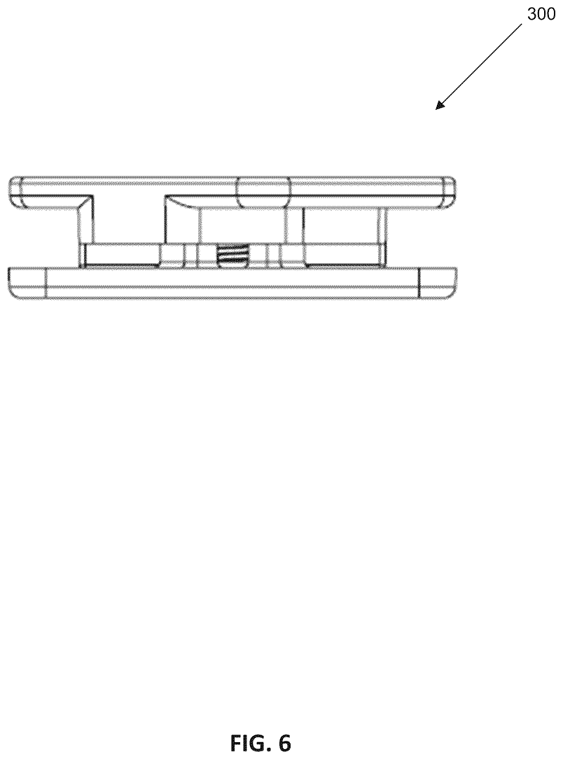

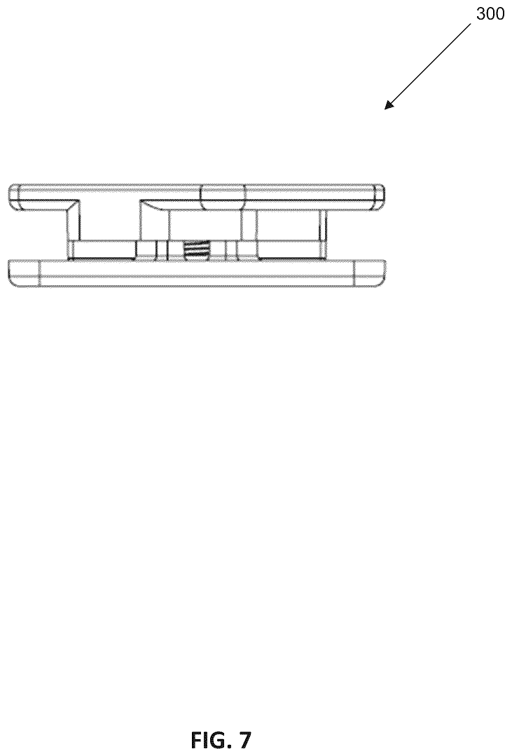

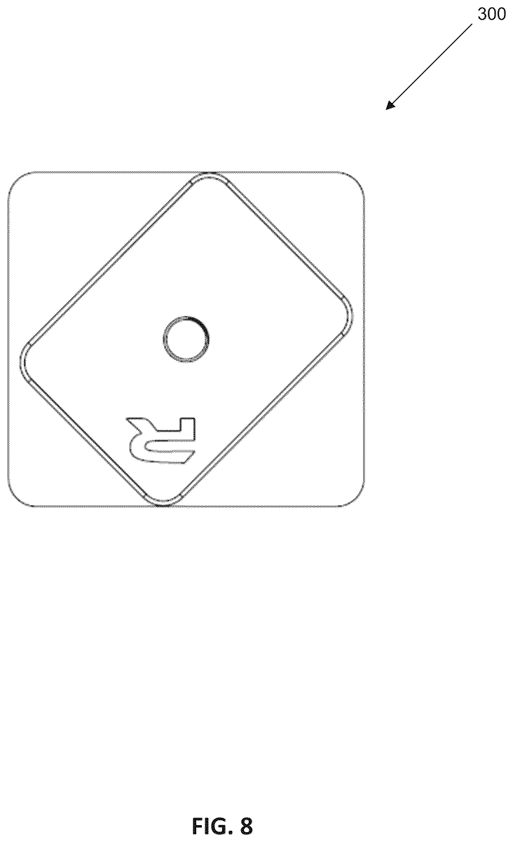

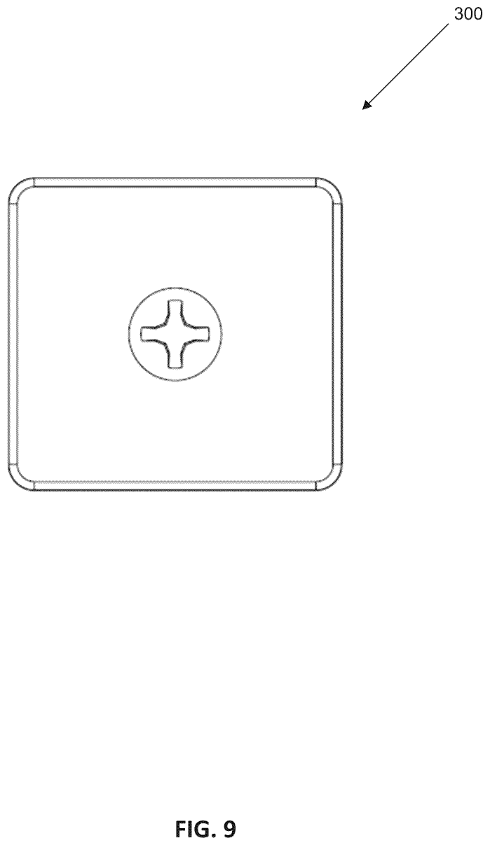

FIGS. 4-9 are alternate views of connector 300.

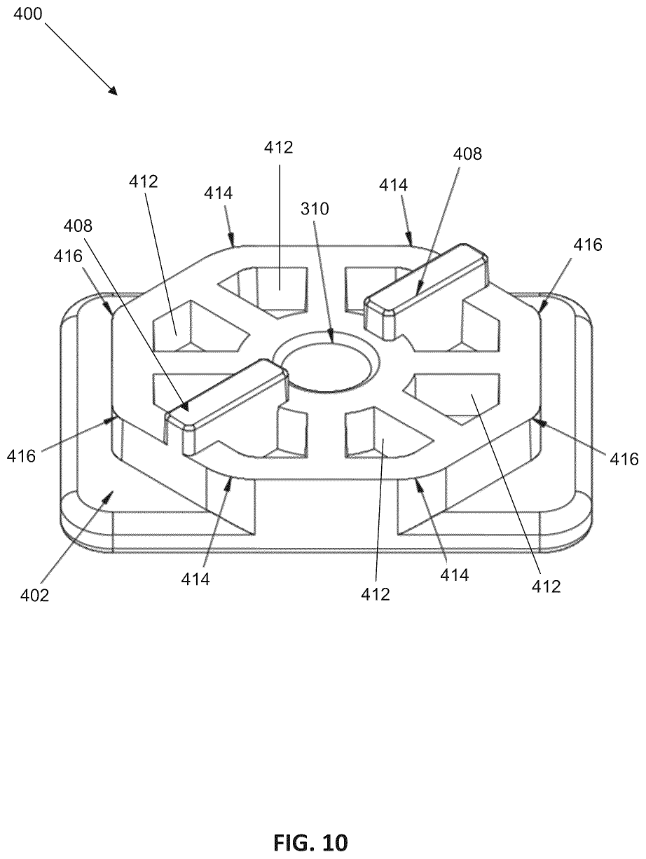

FIG. 10 is an isometric view of the locking plate 400. The top surface of the locking plate 400 that is visible in FIG. 4 is the surface that touches the side of the accessory 200 and connects to the backing plate 500.

The locking plate 400 has an inner ring 402. The inner ring 402 has four soft edges 414 and four hard edges 416. In some examples, the soft edges 414 comprise rounded corners and the hard edges 416 comprise sharp corners. The locking plate 400 also has two locking elevations 408. In some examples, the locking elevations 408 help to provide the gap 350 (discussed with reference to FIG. 4). In some examples, the locking elevations 408 extend into openings of the accessory 200 to help rotatably fix the accessory 200 to the locking plate 400. The inner ring 402 further includes four locking depressions 412. The locking elevations 408 are extruded from the surface of the inner ring 402, and the locking depressions 412 are defined by cavities in the surface of the inner ring 402.

As shown in this embodiment, the locking elevations 408 may be arranged symmetrically about the center of the inner ring 402. The locking depressions 412 may also be arranged in a symmetrical pattern about the center of the inner ring 402. In other embodiments, more locking elevations 408 and more or fewer locking depressions 412 could be implemented. Also, in other embodiments, the locking elevations 408 and locking depressions 412 could both have different shapes than those shown in this illustration.

The shapes of the locking elevations 408 and locking depressions 412 in this embodiment correspond to shapes of aspects of other figures with which they interact, detailed herein. In other embodiments in which the locking elevations 408 and the locking depressions 412 have different shapes than those in this embodiment, the shapes of aspects of other figures would also differ correspondingly. In some examples, the locking elevations 408 and/or the locking depressions 412 are not included.

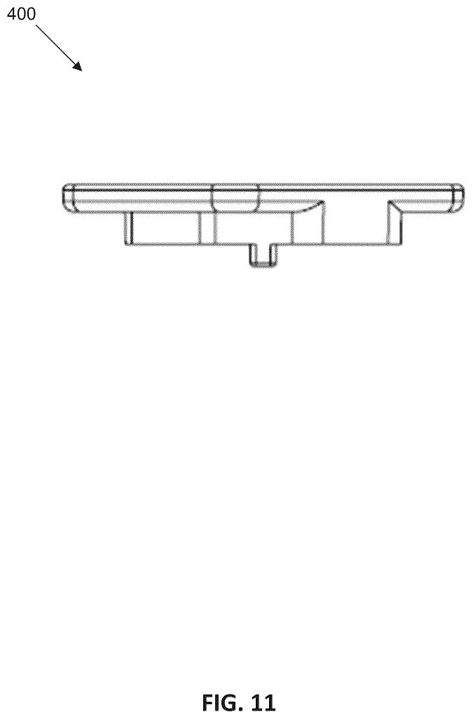

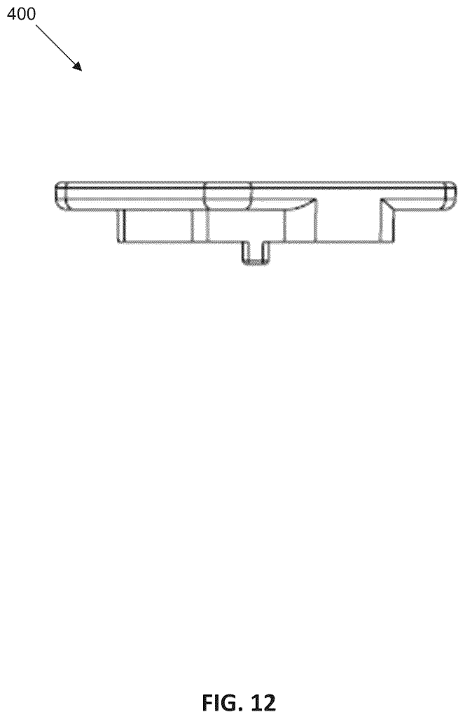

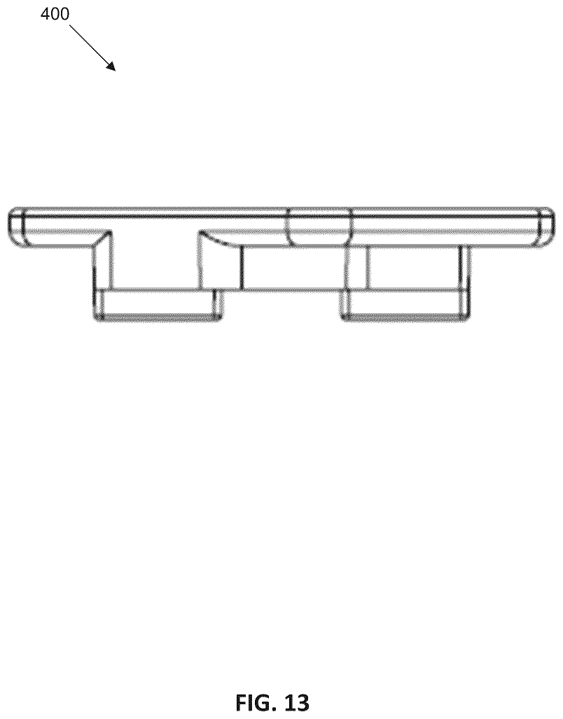

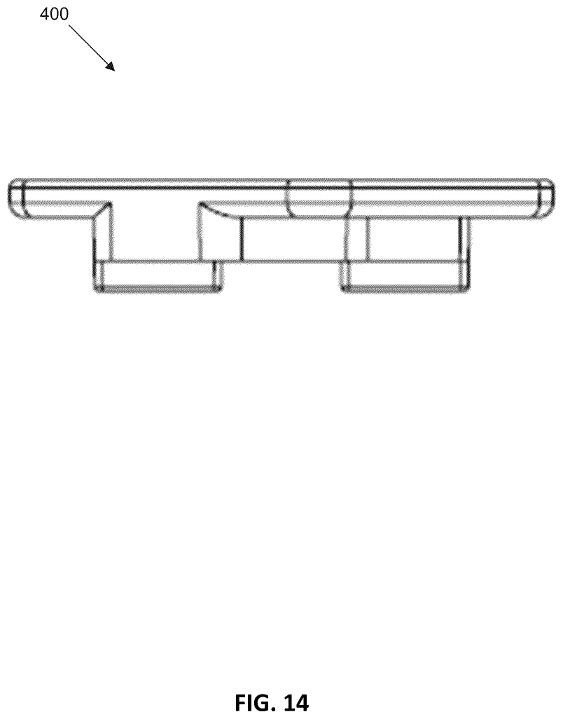

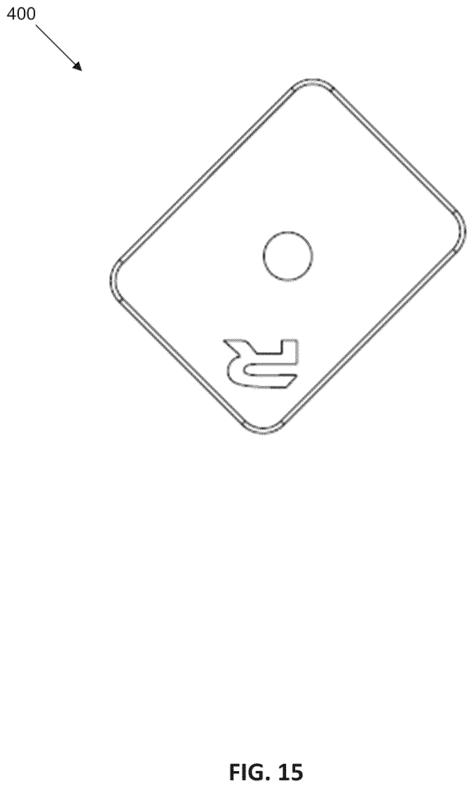

FIGS. 11-16 are alternate views of locking plate 400.

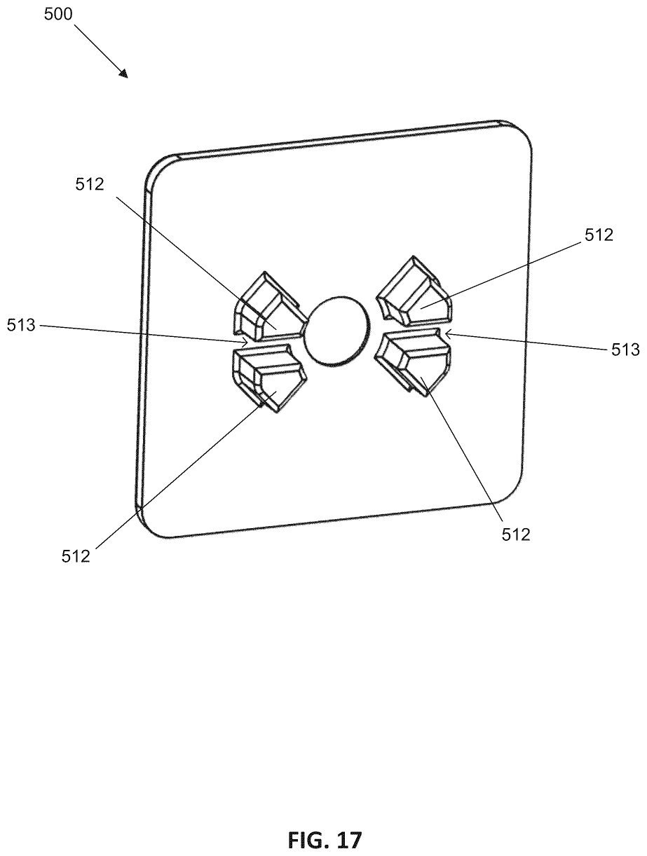

FIG. 17 is an isometric view of the backing plate 500. The backing plate 500 has four backing elevations 512. The backing elevations 512 are arranged about the center of the backing plate 500. As shown in this embodiment, the backing elevations 512 may be arranged symmetrically around the center of the backing plate 500. In other embodiments, the backing elevations 512 may be arranged in some other configuration.

The backing elevations 512 have the same shape as the cavity defining the locking depressions 412. In some examples, there are four backing elevations 512. In other examples, the backing elevations 512 are as numerous as the locking depressions 412 and the backing elevations 512 are arranged in the same positions with respect to the center of the backing plate 500 as the locking depressions 412 are arranged with respect to the center of the locking plate 400. In other embodiments in which the backing elevations 512 have different shapes than those in this embodiment, the shapes of the locking depressions 412 would also differ in a corresponding manner. In some examples, the backing elevations 512 and/or the locking depressions are not included.

In some examples, the backing plate 500 further comprises spaces 513 in between the backing elevations 512. In some examples, the spaces 513 are shaped and sized so as to receive the locking elevations 408.

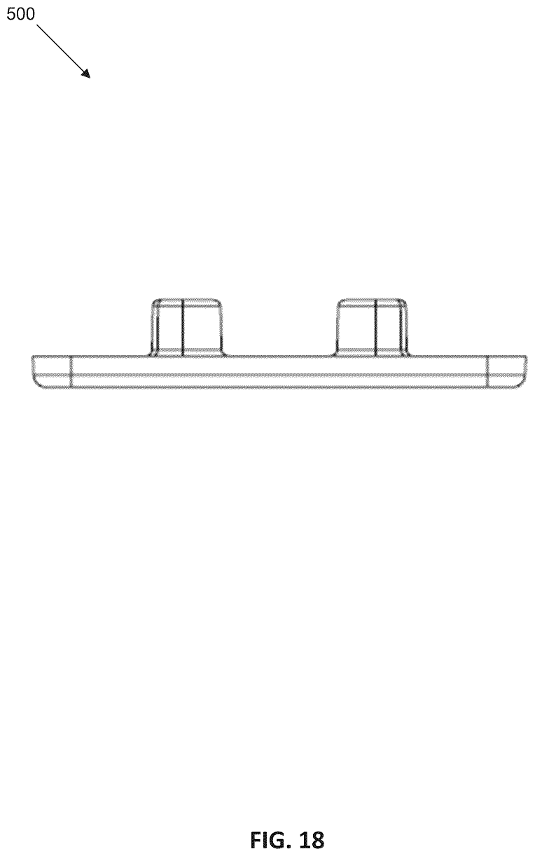

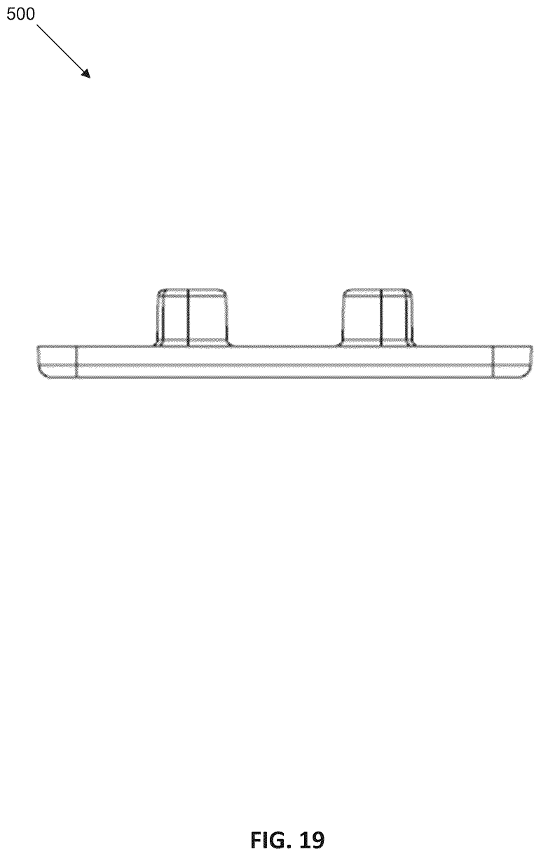

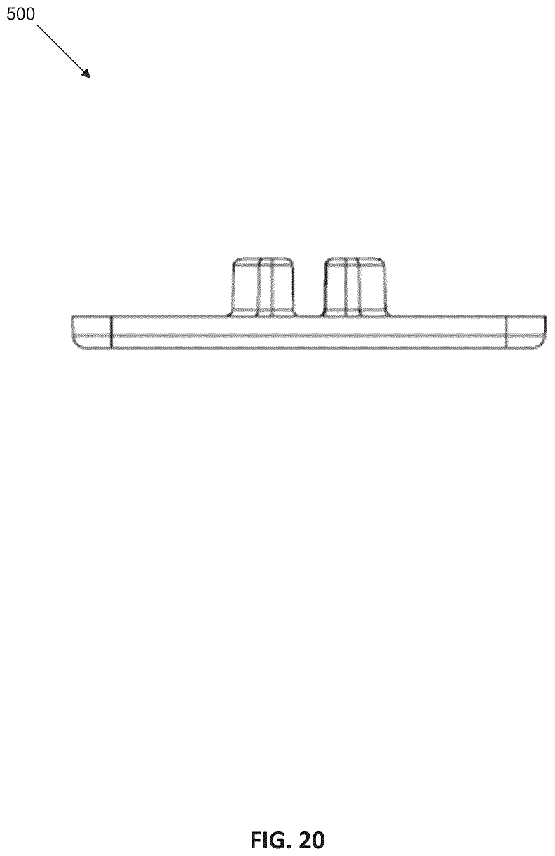

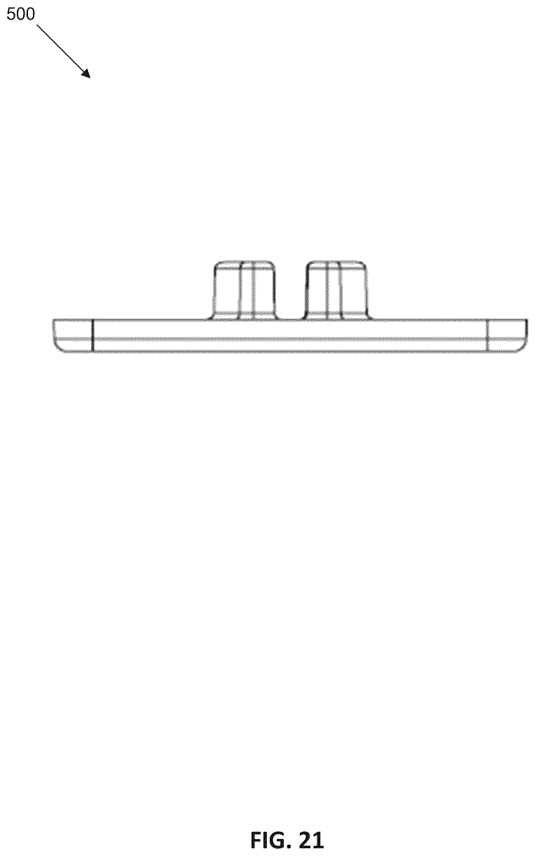

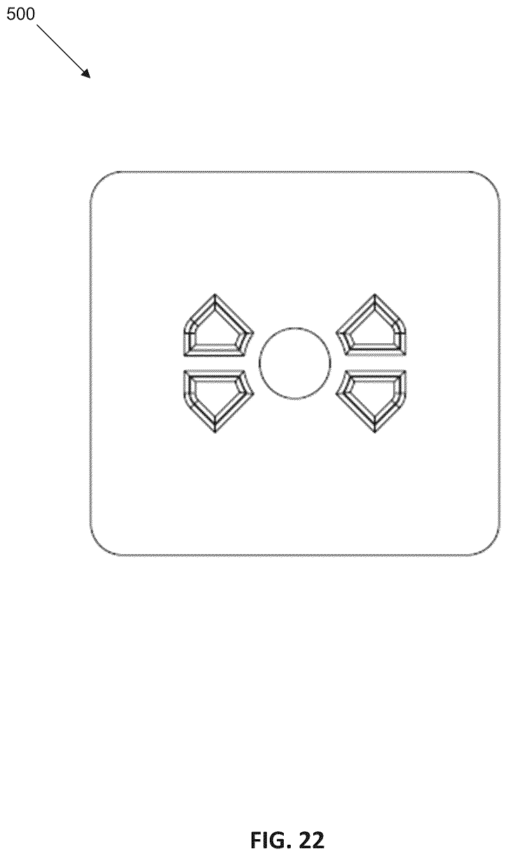

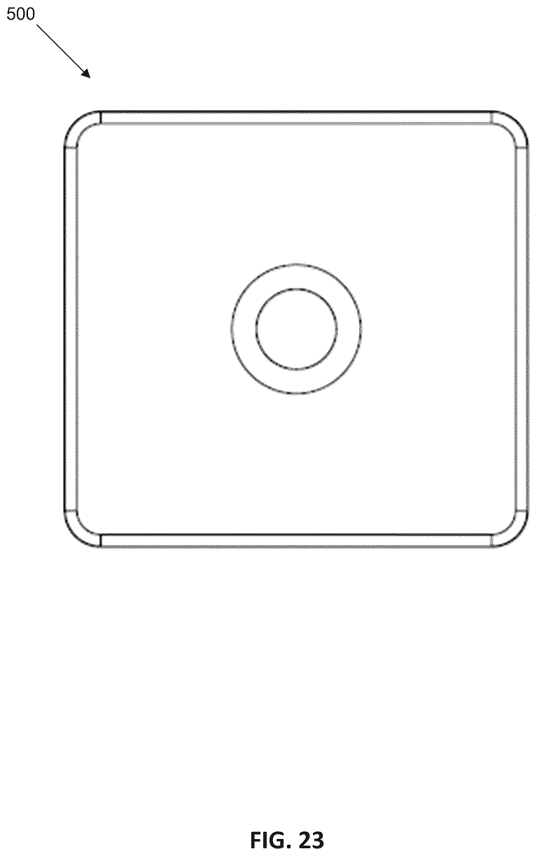

FIGS. 18-23 are alternate views of backing plate 500.

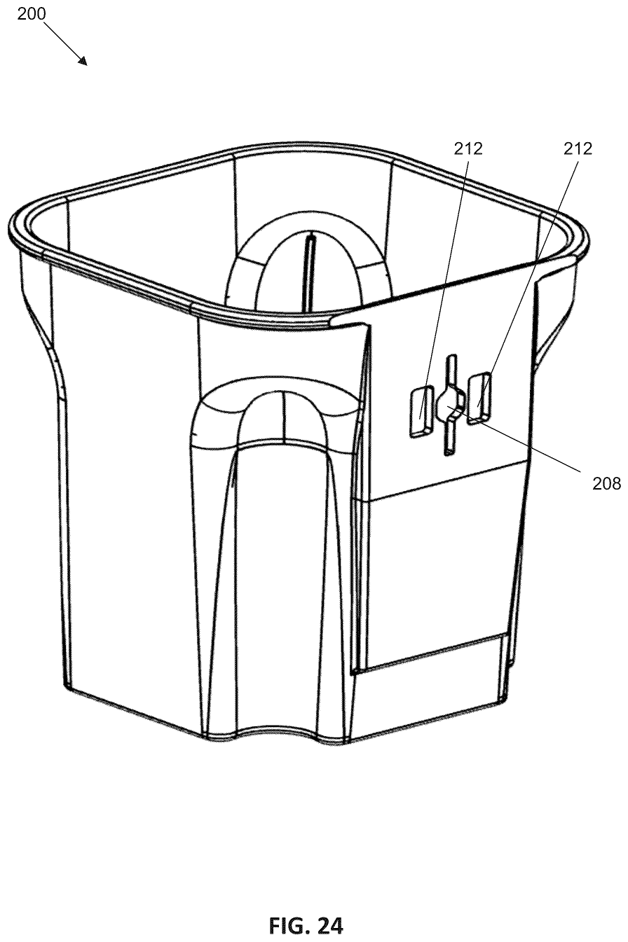

FIG. 24 is an isometric view of the accessory 200. As shown in this embodiment, the accessory 200 may be suited for holding an object such as a cup. In other embodiments, the accessory 200 may have other shapes.

As shown in this embodiment, the accessory 200 has two openings 212 defined by rectangular cutouts in one of the sides of the accessory 200. In other embodiments, the openings 212 may have other shapes. The openings 212 are large enough and arranged such that the backing elevations 512 can fit through them when the backing plate 500 is held adjacent to the inside surface of the accessory 200 with the backing elevations 512 facing the openings 212.

When the backing plate 500 is held adjacent to the inside surface of the accessory 200, the backing elevations 512 protrude through the openings 212 in the side of the accessory 200. The accessory 200 also has a keyhole 208 between its openings 212. The keyhole 208 is defined by a circular cutout with two rectangular cutouts emerging in opposite directions vertically from the circle's edge. The middle circular portion of the keyhole 208 allows a screw or bolt to be passed through the backing plate 500, accessory 200, and locking plate 400, causing them to be conjoined.

The outer rectangular portions of the keyhole 208 fit snugly around the locking elevations 408 when the locking plate 400 of the connector 300 is held adjacent to the outside surface of the accessory 200. In other embodiments, the keyhole 208 could have an alternative shape if it allows a screw or other fastener to pass through the backing plate, accessory, and connector and provided that the locking elevations 408 fit into the keyhole 208.

When the backing plate 500, accessory 200, and locking plate 400 are conjoined, the backing plate 500 and locking plate 400 are fixed in their position relative to the accessory 200. The keyhole 208 prevents the locking plate 400 from rotating relative to the accessory 200 because the locking elevations 408 fit snugly within the rectangular portions of the keyhole 208. The backing elevations 512 prevent the backing plate 500 from rotating relative to the locking plate 400 (and thus also the accessory) because the backing elevations 512 fit snugly within the locking depressions 412. In other examples, the locking plate 400 may be moved independently from the backing plate 500.

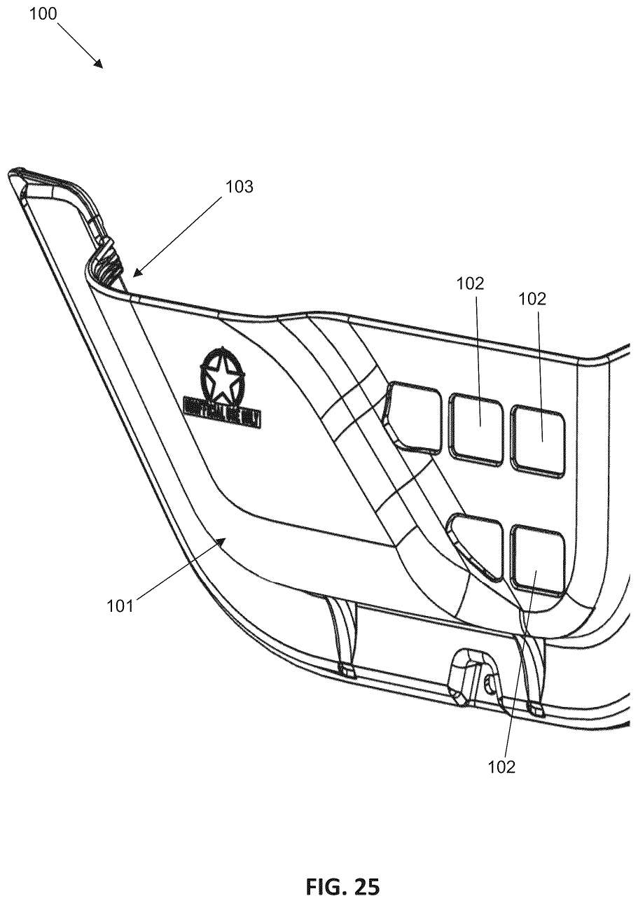

FIG. 25 is an isometric view of the attachment panel 100. As shown in this embodiment, the attachment panel 100 has at least one opening 102. If there is more than one openings 102, the openings 102 can be arranged in rows and columns, as shown in this embodiment. In other embodiments, the openings 102 can be organized in other configurations. The openings 102 are identical in size and have a rectangular shape with rounded corners. Other embodiments may have openings 102 with different shapes and sizes, though the openings 102 still must be identical.

The locking plate 400 is sized such that the locking plate can pass through the opening 102 while the locking plate 400 is attached to the backing plate 500 with the wall of the accessory 200 between them. In some examples, the locking plate 400 passes through an opening 102 to connect the accessory 200 to the attachment panel 100.

In some examples, the attachment panel 100 includes a front side 101 and a rear side 103.

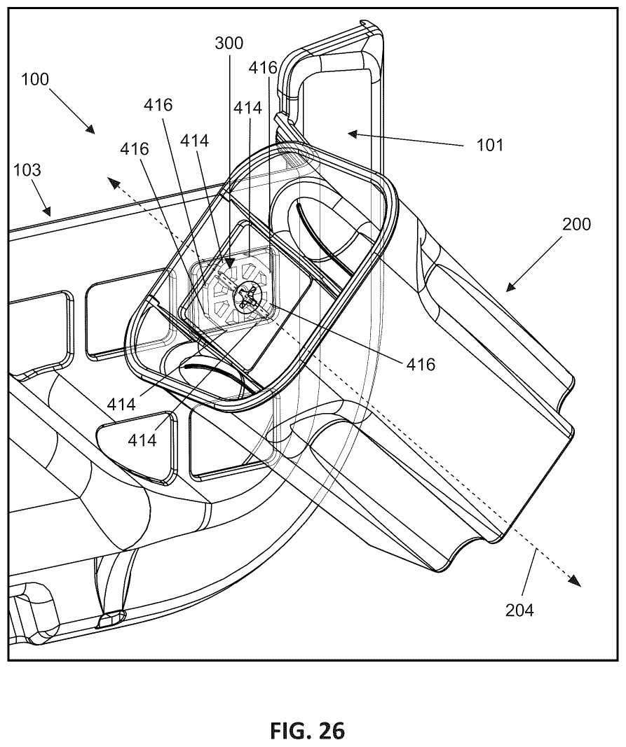

FIG. 26 is an isometric view of the attachment panel 100 and the accessory 200 both configured to the connector 300. The locking plate 400 is extended through the opening 102 such that it is positioned on the rear side 103 of the attachment panel 100. The backing plate 500 is positioned on the front side 101 of the attachment panel 100. The side of the accessory 200 is arranged between the locking plate 400 and the backing plate 500 and is also positioned on the front side 101 of the attachment panel 100. The connector 300 is in an unlocked position. In the unlocked position, neither the soft edges 414 nor the hard edges 416 contact the boundaries of the opening 102. In some examples, when in the unlocked position, the accessory 200 is free to be moved away from the front side 101 of the attachment panel 100. In some examples, when in the unlocked position, the accessory 200 is arranged such that the accessory axis 204 is not at a vertical position.

In some examples, to move from the unlocked position to the locked position, a user rotates the connector 300 and accessory 200 such that the soft edges 414 are placed into contact with the boundaries of the opening 102. As the soft edges 414 are placed into contact with the boundaries of the opening 102, the connector 300 and accessory 200 will generate a first resistance to rotation. Additional force is applied to continue rotating the connector 300 and accessory 200 such that the force is overcome as the connector 300 is moved into the locked position. Should the user continue rotating the connector 300 and accessory 200, the hard edges 416 will contact the boundaries of the opening 102. In some examples, when the hard edges 416 contact the boundaries of the opening 102, the connector 300 and accessory 200 will generate a second resistance to rotation that is greater than the first resistance. In some examples, the hard edges 416 are sized and shaped such that the connector 300 and accessory 200 cannot be rotated out of the locked position past the hard edges 416 and must instead be rotated back over the soft edges 414 out of the locked position.

In some examples, the soft edges 414 are sized and shaped such that the first resistance is sufficiently high to prevent the connector 300 from being rotated out of the locked position accidentally, and instead, a user must intentionally rotate the connector 300 out of the locked position by generating sufficient force to overcome the first resistance and overcome an interference fit between the soft edges 414 and the boundaries of the opening 102.

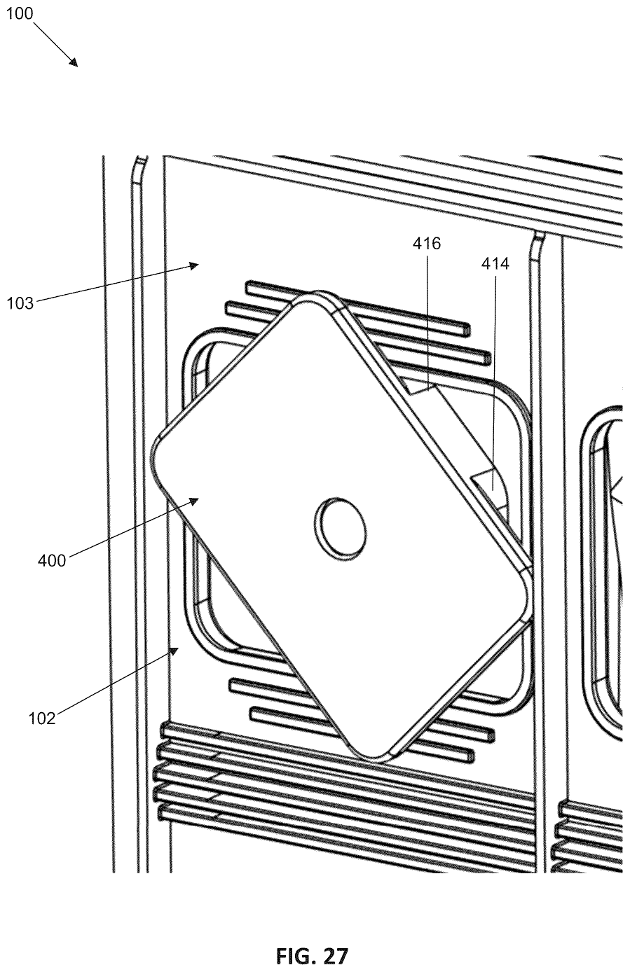

FIG. 27 is an isometric view of the locking plate 400 connected behind the rear side of the attachment panel 100. The locking plate is attached to the remainder of the connector 300, which is in a locked position. In the locked position, the hard edges 416 resist further rotation of the connector beyond the locked position, although the hard edges 416 do not restrict rotation of the connector back to the unlocked position.

In the locked position, the connector 300 is fixed in its position relative to the attachment panel 100. The user cannot move the connector 300 closer to or further away from the attachment panel 100. The edges of the locking plate 400 are not parallel with the edges of the opening 102, which prevents the connector 300 from moving. Therefore, in the locked position, the connector 300 cannot easily rotate about the axis of the center hole 310, nor can it move closer to or further away from the attachment panel 100.

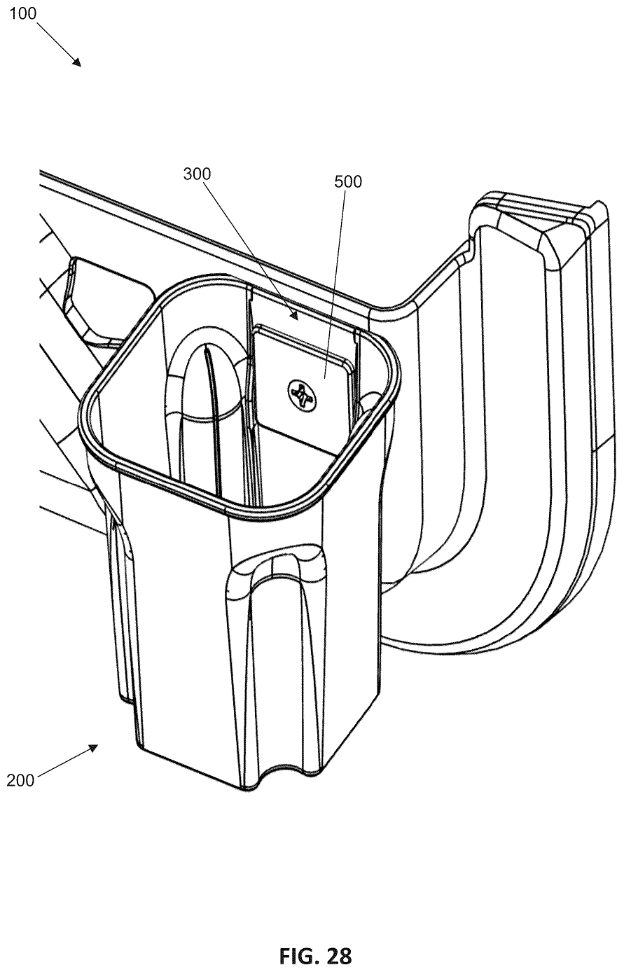

FIG. 28 is an isometric view of the attachment panel 100 and the accessory 200 connected to the connector 300. The backing plate 500 is attached to the remainder of the connector 300 by a screw. In other embodiments, the backing plate 500 may be attached to the rest of the connector 300 using another object such as a bolt or adhesive.

The connector 300 is in a locked position. To move the connector 300 from a locked to an unlocked position, a user standing in the place of one looking at the accessory 200 from the perspective of FIG. 28 rotates the accessory 200 about the center of the backing plate 500 in a counterclockwise direction over the soft edges 414 of the locking plate 400. Once the connector 300 is in an unlocked position, the user can remove the accessory 200 from the attachment panel 100 by moving the accessory in a straight line normally from the surface of the attachment panel 100 toward the user.

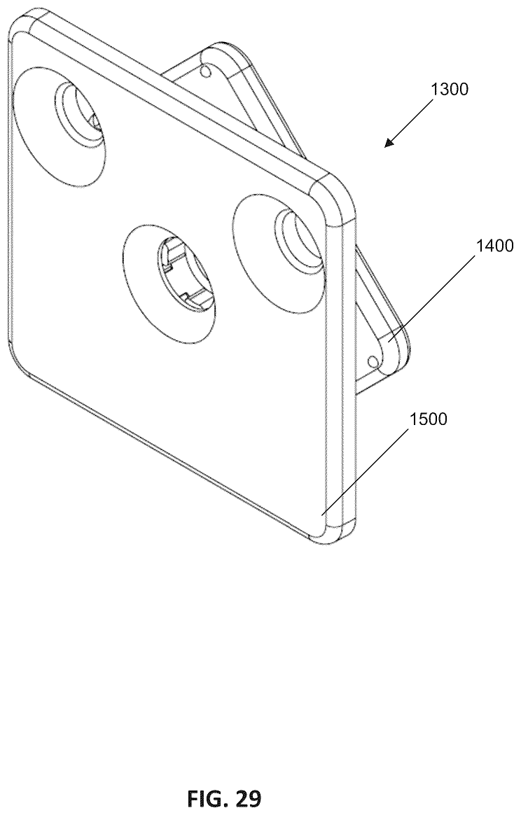

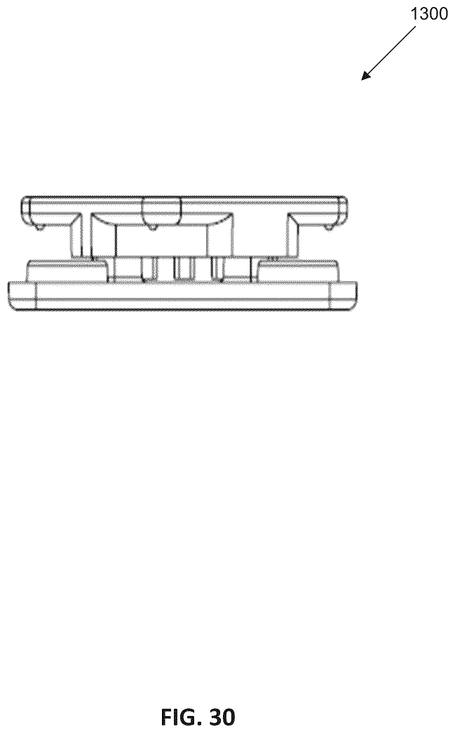

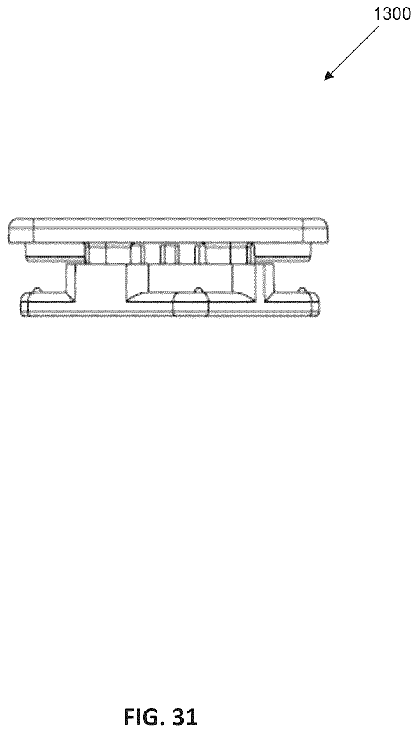

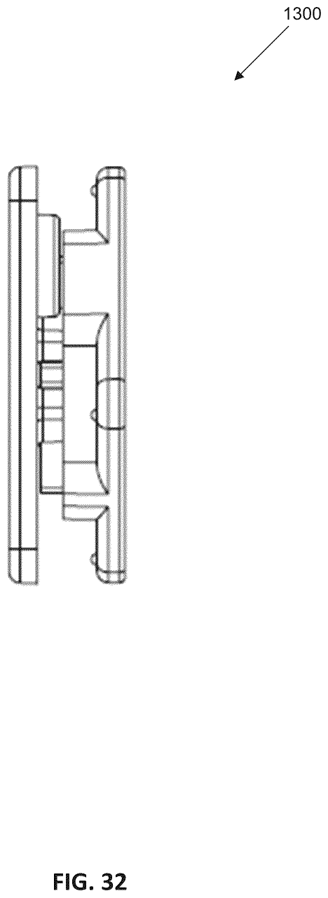

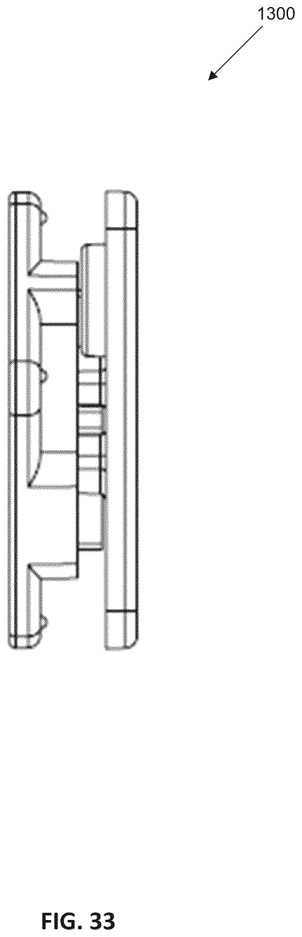

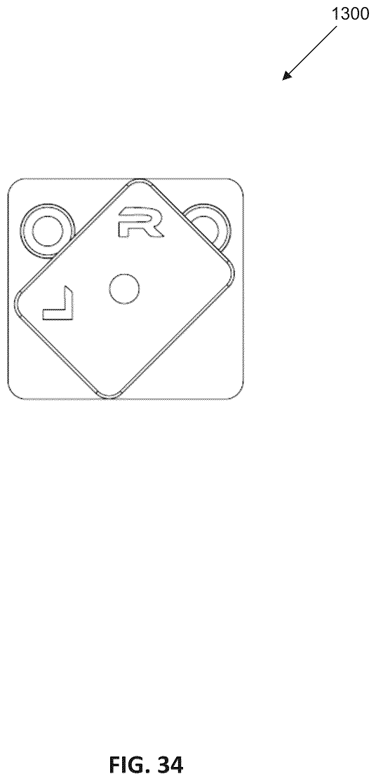

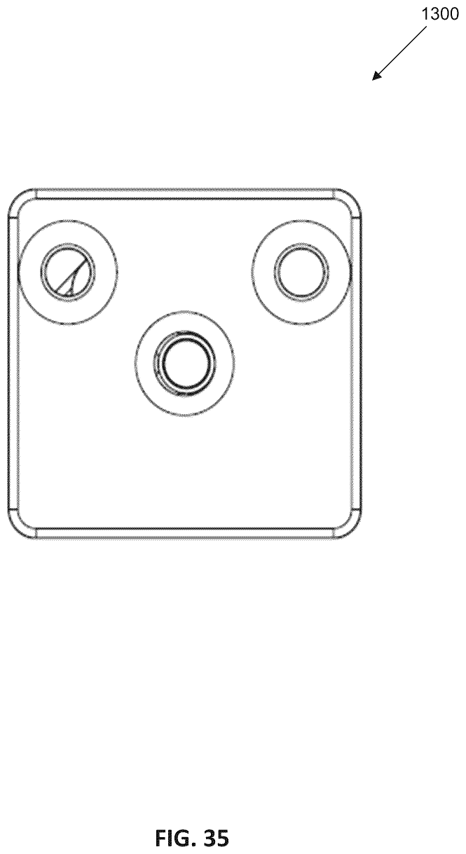

FIG. 29 is an isometric view of an alternate connector 1300 comprised of a locking plate 1400 and backing plate 1500. In many aspects, connector 1300 is similar to connector 300 as described with respect to FIGS. 1-28. Similarly, connector 1300 may be used in a similar manner to the connector 300 described with respect to FIGS. 1-28. FIGS. 30-35 show alternate views of connector 1300.

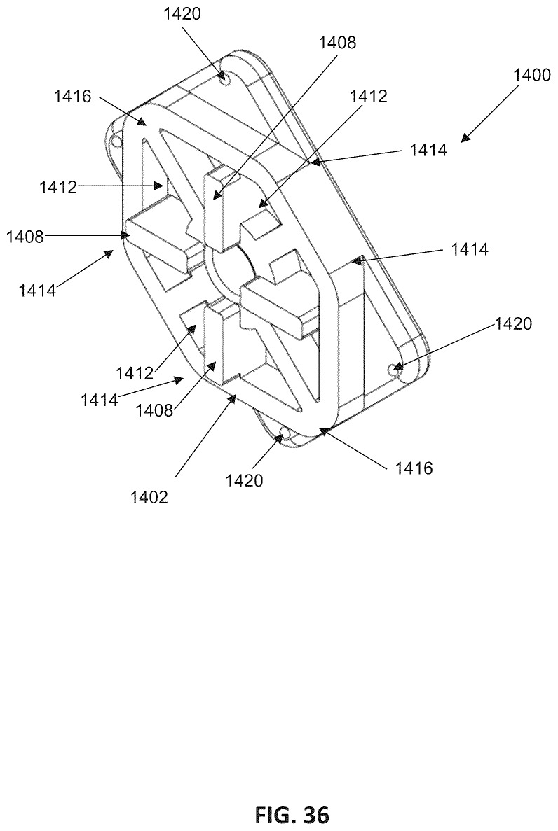

FIG. 36 is an isometric view of an alternate locking plate 1400. In some embodiments, locking plate 1400 has an inner ring 1402 having four sides, such that inner ring 1402 has an elongated hexagon shape. Inner ring 402 may include four soft edges 1414, and two hard edges 1416, where each of the two hard edges 1416 are positioned on opposite sides of the inner ring 1402 between two of the soft edges 1414. In some examples, the soft edges 1414 comprise rounded corners and the hard edges 1416 comprise sharp corners. In some examples, each of the hard edges 1416 comprise an acute angle and each of the soft edges 1414 comprise an obtuse angle. In some examples, the hard edges 1416 are sized and shaped such that the connector 1300 and accessory 200 cannot be rotated out of the locked position past the hard edges 1416 and may instead only be rotated back over the soft edges 1414 in and out of the locked position. In some examples, rotation of the locking plate 1400 within the attachment panel 100 creates an interference fit between the soft edges 1414 and edges on either side of the opening height 106 as the connector 1300 is rotated. In some examples, when arranged in the locking panel 100 in the unlocked position, the sides of the inner ring 1402 extending between two soft edges 1414 extend parallel to an axis of the opening length 104 of the opening 102 of the attachment panel 100. In some examples, when arranged in the locking panel 100 in the locked position, the sides of the inner ring 1402 extending between a soft edge 1414 and a hard edge 1416 extend perpendicular or parallel to an axis of the opening length 104 or opening height 106 of the opening 102, while the sides of the inner ring 1402 extending between two soft edges 1414 extend at a non-perpendicular angle to an axis of the opening length 104 or opening height 106 of the opening 102.

In some embodiments, locking plate 1400 includes four locking elevations 1408 arranged symmetrically about the center of the inner ring 1402. Locking plate 1400 additionally includes locking depressions 1412 arranged in a symmetrical pattern about the center of the inner ring 1402 and defined by cavities in the surface of the inner ring 1402.

In some embodiments, locking plate 1400 includes protrusions 1420. Protrusions 1420 may be arranged on a surface of locking plate 1400 outside inner ring 1402. Protrusions 1420 may be located at a corner of locking plate 1400. Protrusions 1420 prevent movement of the connector 1300 by creating friction between locking plate 1400 and attachment panel 100 when the connector 1300 is installed in the locked position.

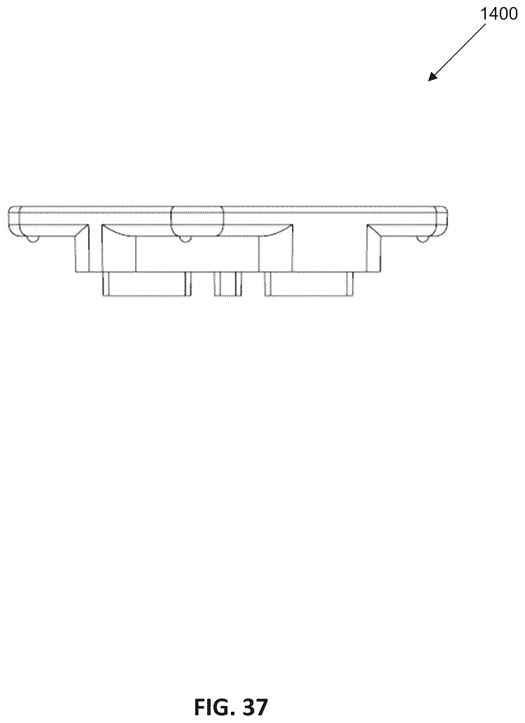

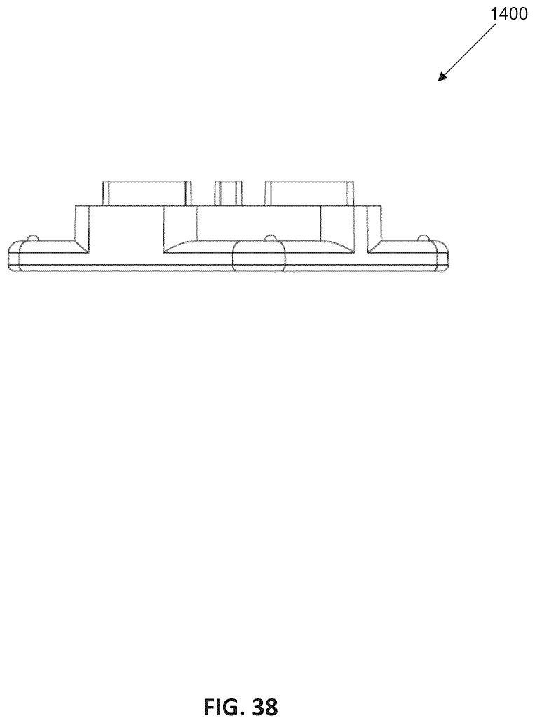

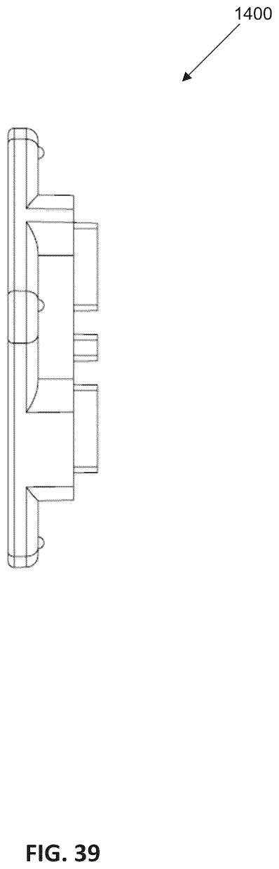

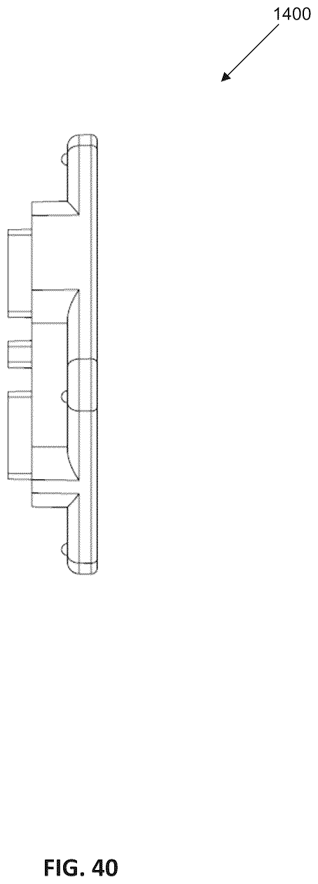

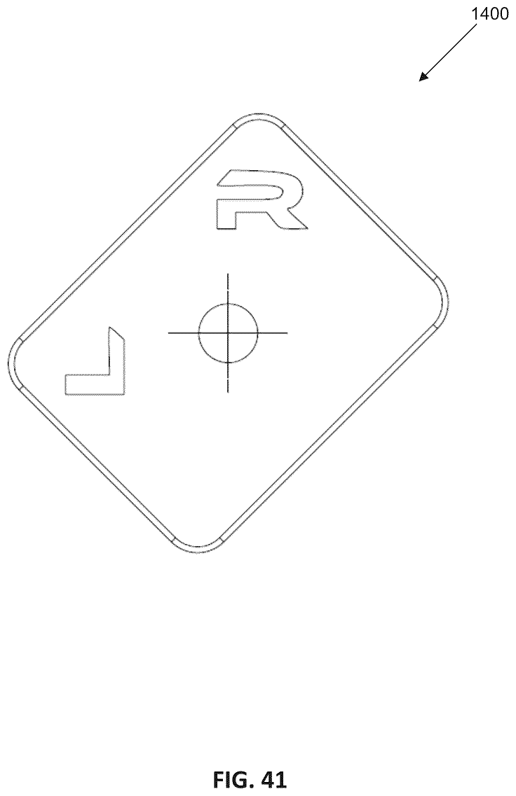

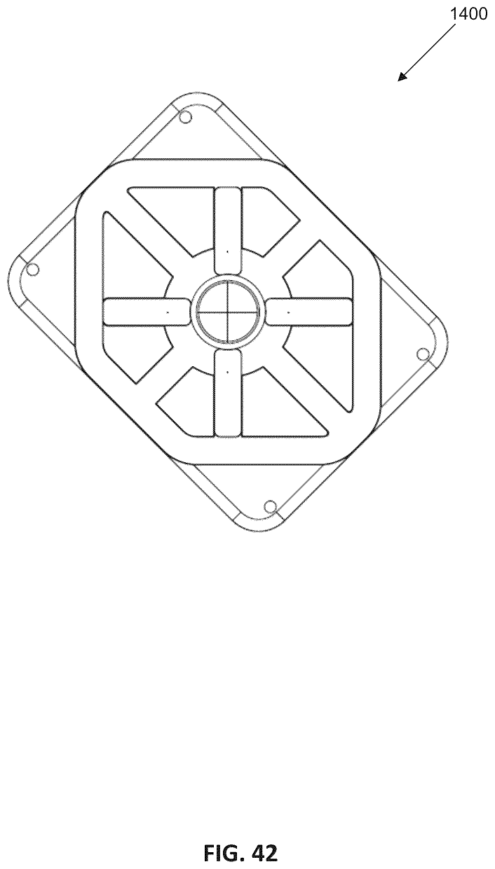

FIGS. 37-42 are alternate views of locking plate 1400

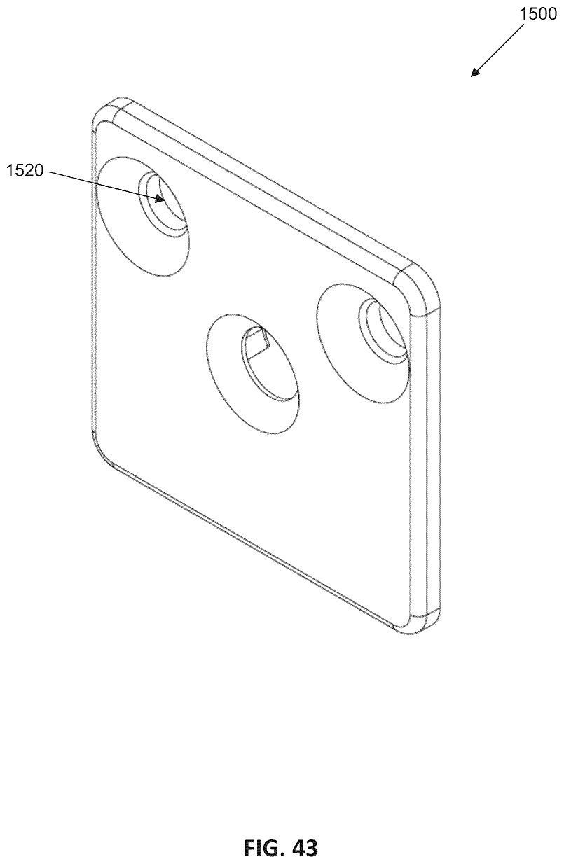

FIG. 43 is an isometric view of backing plate 1500. In some embodiments, backing plate includes four backing elevations 1512 arranged around the center of the backing plate 1500. Backing elevations 1512 may be arranged in the same positions with respect to the center of the backing plate 1500 as the locking depressions 1412 are arranged with respect to the center of the locking plate 1400. Backing plate 1500 may additionally include a number of threaded openings 1520. Threaded openings 1520 are configured to receive fasteners when connector 1300 is installed in the locked position such that connector 1300 may be fixed in the locked position. In some examples, when the fasteners are arranged through the threaded openings 1520 while the connector 1300 is arranged through the attachment panel 100, the connector is rotatably fixed with respect to the attachment panel 100.

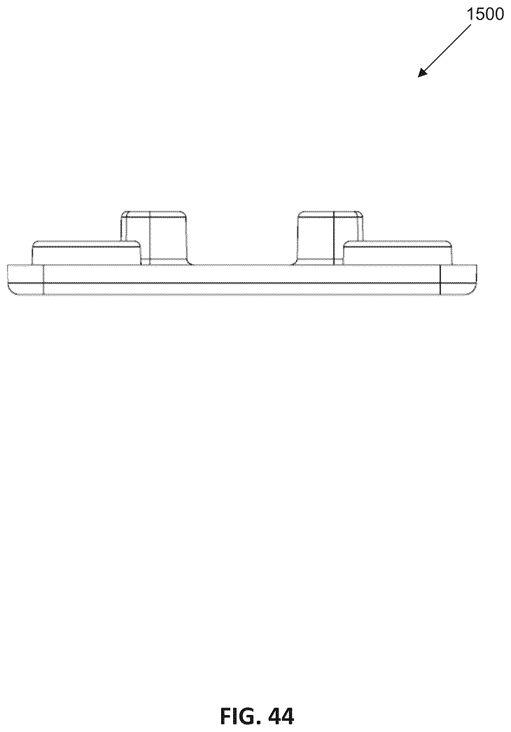

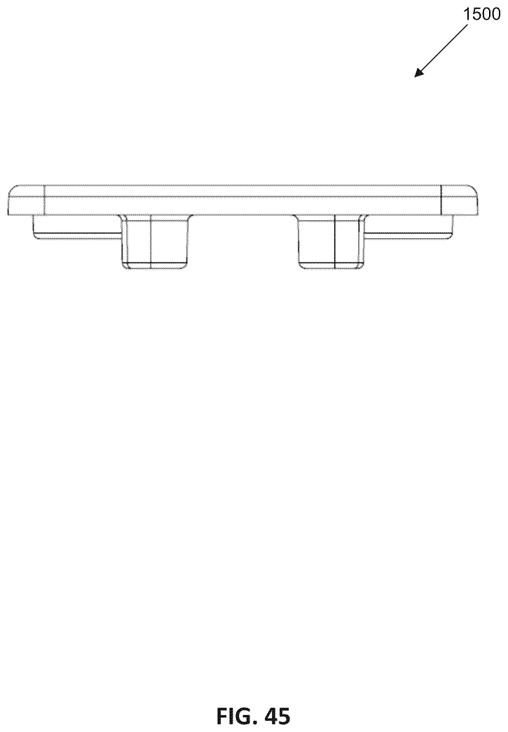

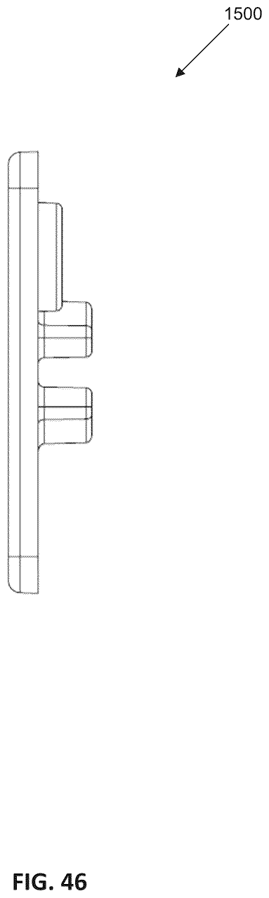

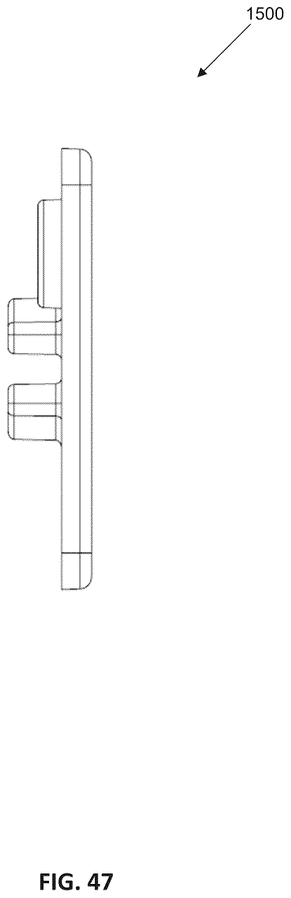

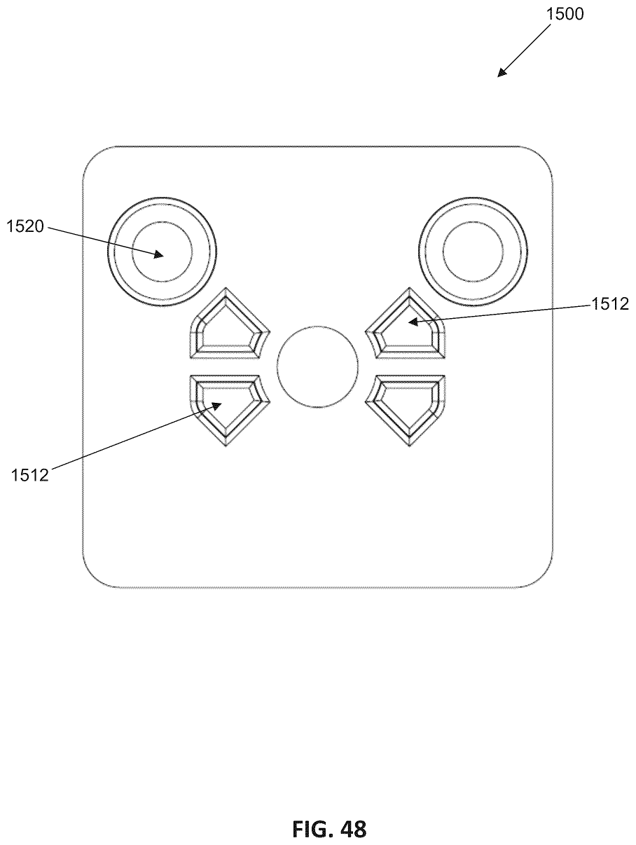

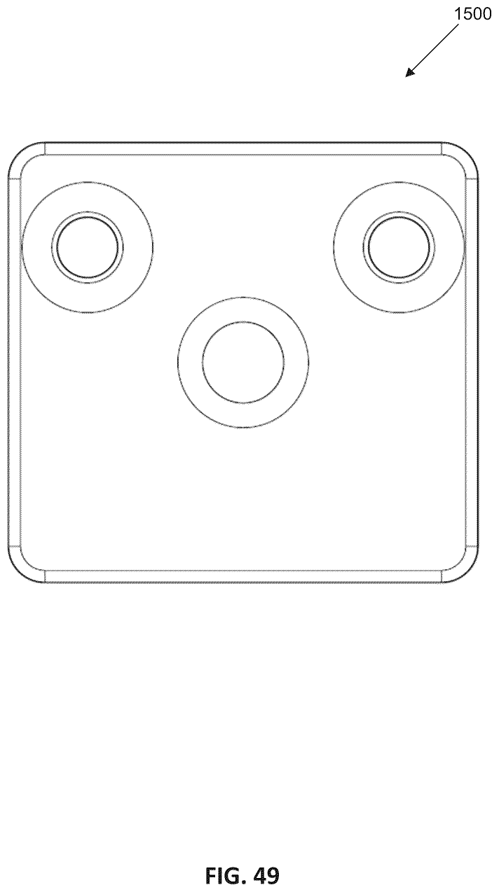

FIGS. 44-49 are alternate views of backing plate 1500.

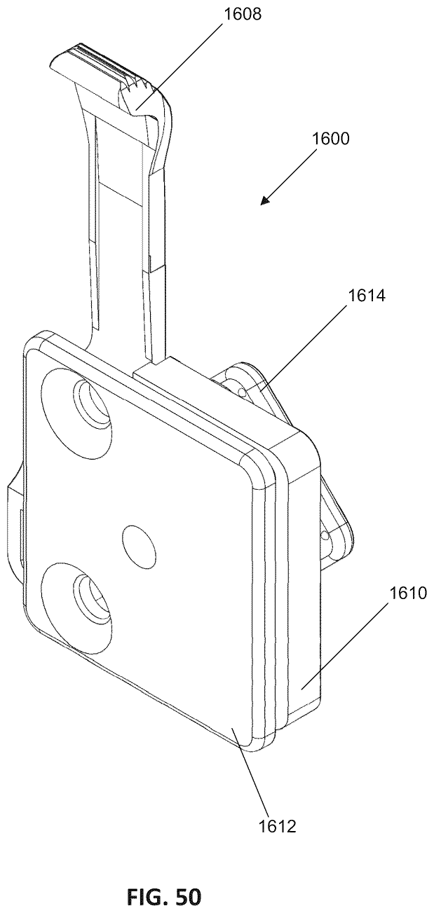

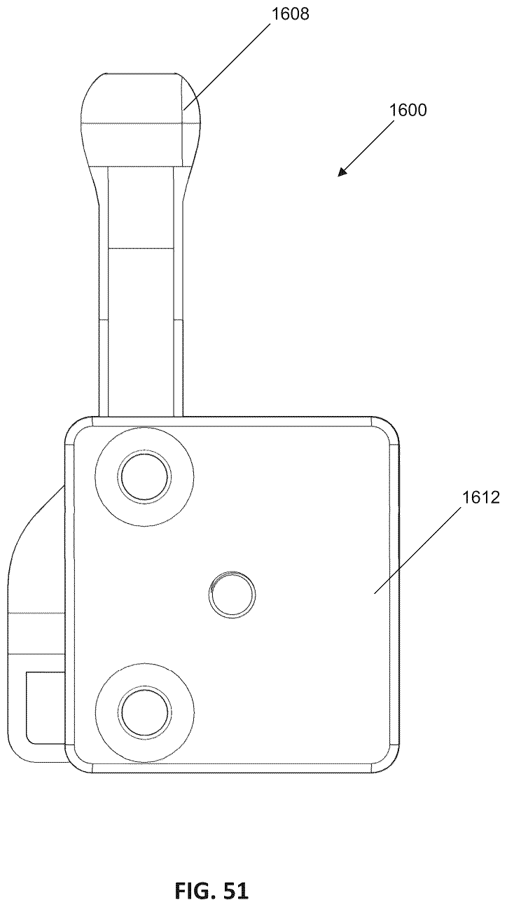

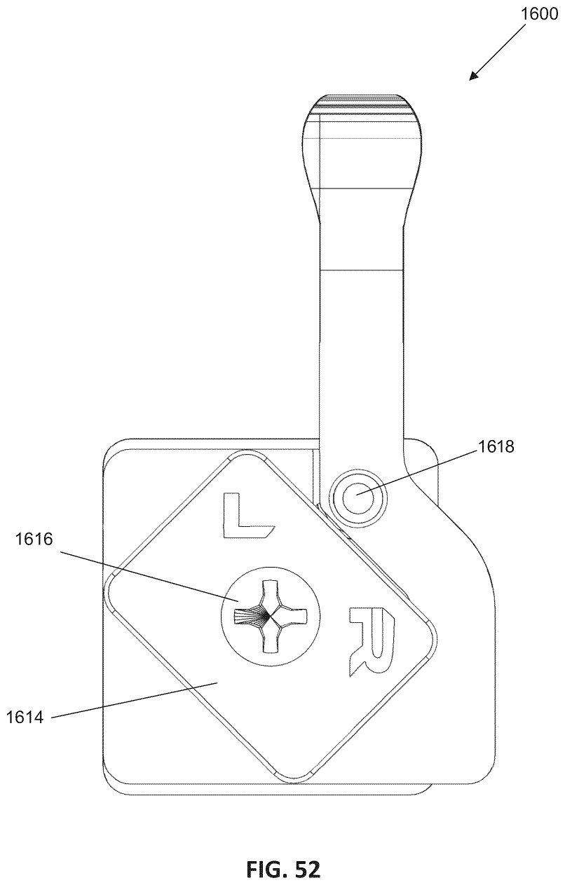

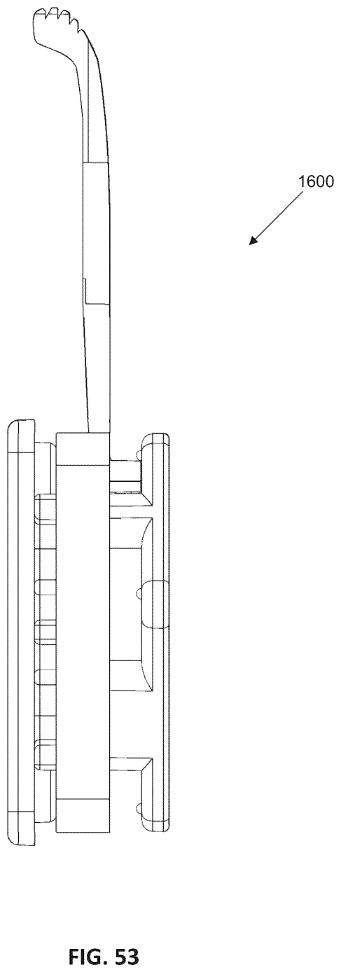

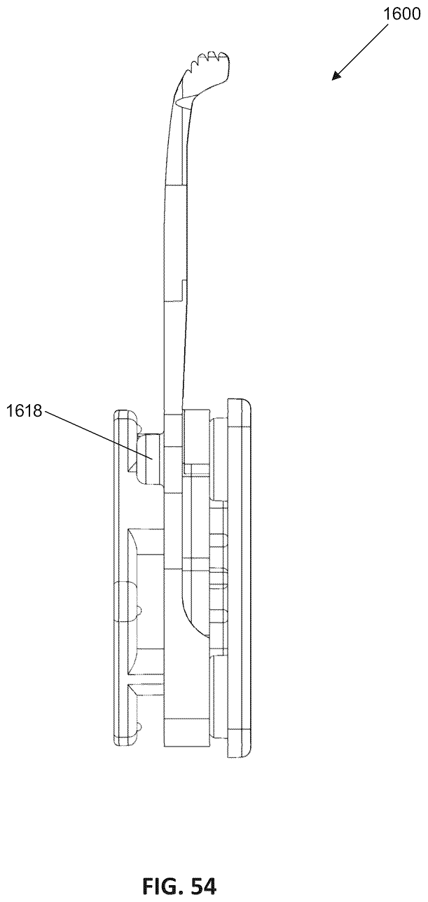

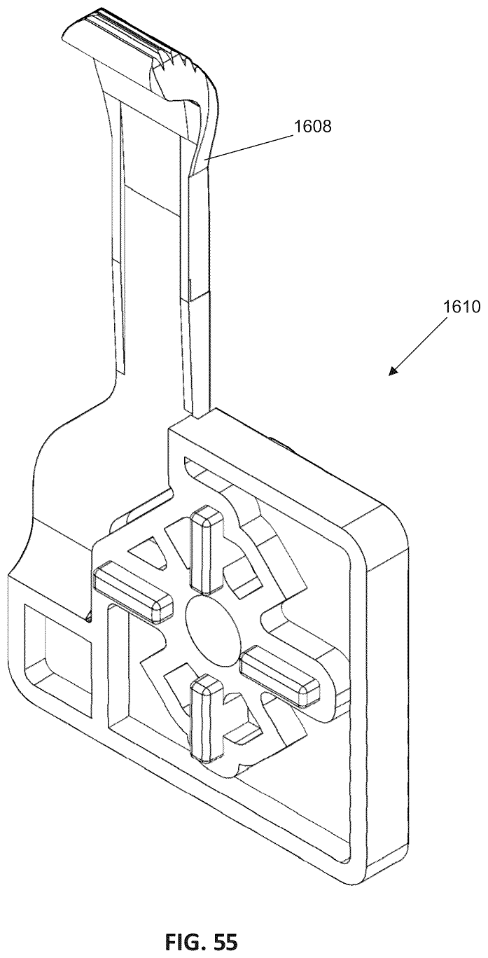

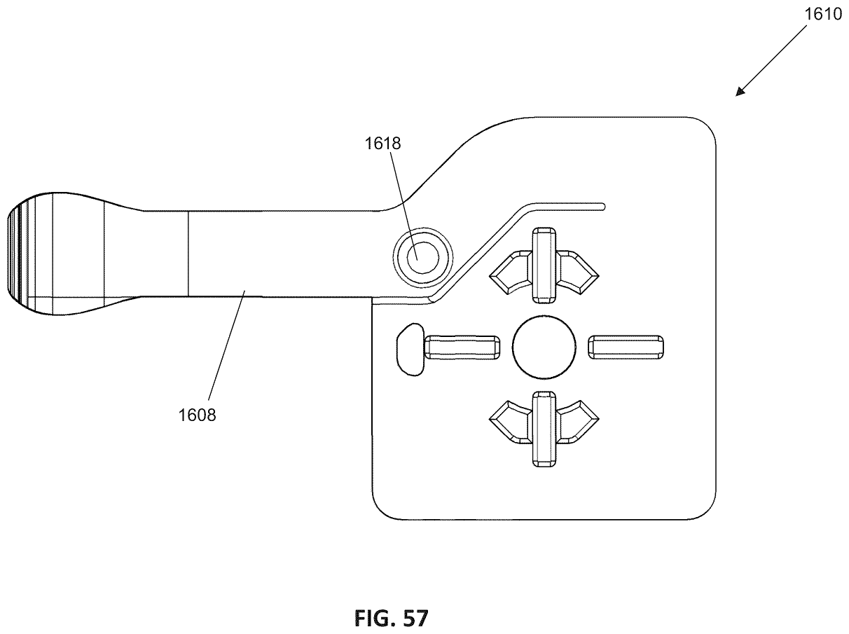

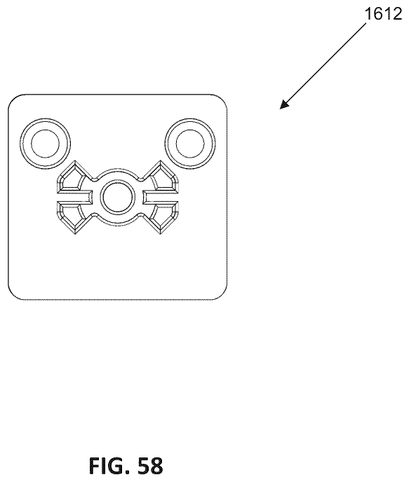

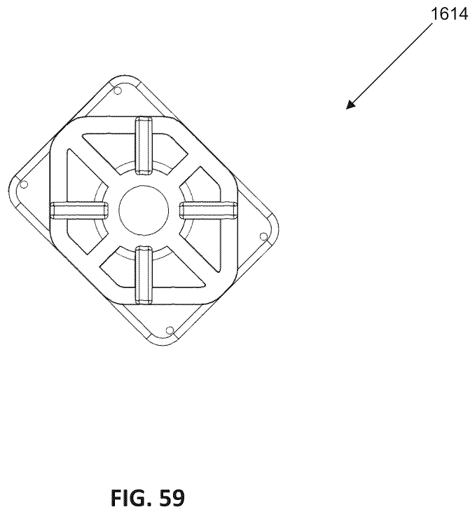

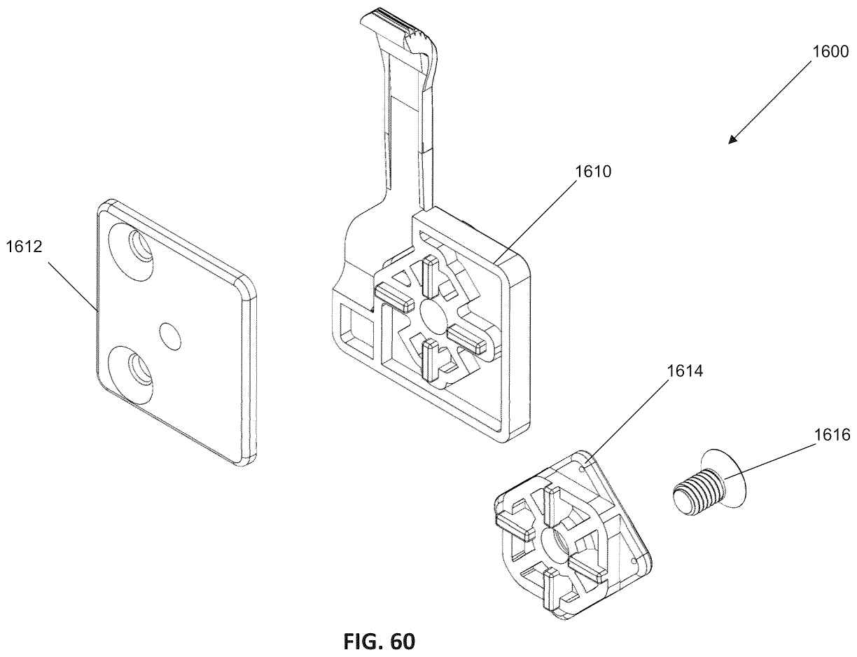

FIGS. 50-60 illustrate an example embodiment of the connector 1600. The connector 1600 may be used as the connector 300 in some cases. In the shown embodiment, the connector 1600 includes a release plate 1610 with a release lever 1608, a locking plate 1614, a backing plate 1612, a fastener 1616, and a protrusion 1618.

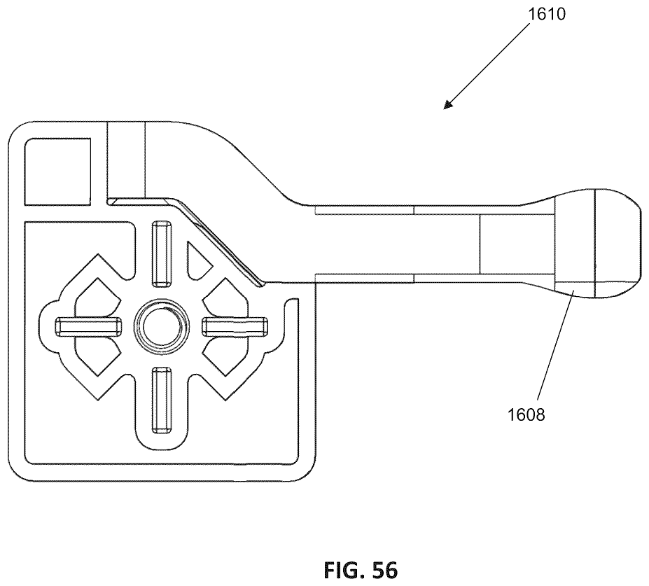

In some embodiments, the connector 1600 operates similarly to the connector 300. For example, the release plate 1610 includes similar elevations, projections, and recesses as the backing plate 1500 that enables the connection between the release plate 1610 and the locking plate 1614. Further, the release plate 1610 includes additional elevations and recesses as shown in FIG. 56 to connect to the backing plate 1612. The backing plate 1612, the release plate 1610, and the locking plate 1614 can be attached together with the fastener 1616, which may be a bolt, screw, or other fastener type. The bolt fastener 1616 may be secured through a hole through each of the backing plate 1612, the release plate 1610, and the locking plate 1614. The hole through each the backing plate 1612, the release plate 1610, and the locking plate 1614 may be centrally located. In some embodiments, the release plate 1610 includes compatible recesses and elevations to connect with the backing plate 1612 and the locking plate 1614.

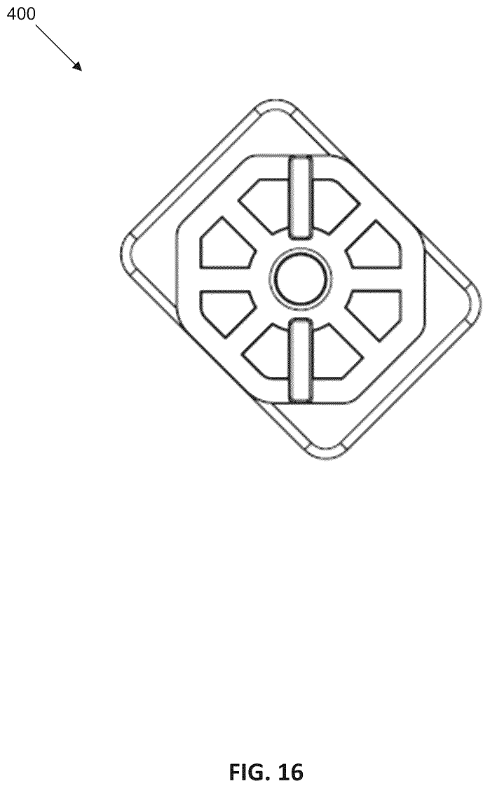

The locking plate 1614 may be the same or use a similar design as the locking plate 1400. In some embodiments, the shown hexagon design includes a soft edge and a hard edge. Further, the inner ring of the hexagon design may include one or more sides that define the outer boundary of the inner ring between the hard edges and soft edges. The sides may include a first length that has increased surface area when contacting an edge of the MOLLE panel as compared to the design of FIG. 16.

Also, the backing plate 1612 may be the same or use a similar design as the backing plate 1500. The plates may function the same or similar way as the described components.

Further, the release plate 1610 can be used to lock the connector in place. The protrusion 1618 can fit within an aperture or hole. In some embodiments, the protrusion 1618 fits within a corner of a MOLLE panel while installed. The MOLLE panel may be a rectangular shape. The protrusion 1618 may prevent the connector 1600 from rotating while the protrusion 1618 is within the corner of the MOLLE panel. Thus, the connector 1600 is further secured and locked in the attachment panel of the door.

The release plate 1610 includes the release lever 1608 to release the protrusion 1618 from the aperture or corner of the MOLLE panel. For example, the release lever 1608 may be constructed of a flexible material (e.g., a plastic) that enables the release lever to flex away from the MOLLE panel. The protrusion 1618 can then move out of the corner or aperture. With the protrusion 1618 free, the connector 1600 may rotate freely. In some embodiments, the release plate 1610 design enables a more convenient lock and release mechanism than locking the connector 1600 with a screw into the attachment panel. Further, the protrusion 1618 adds additional support to increase the sturdiness of the connector 1600 and the connected attachment.

In some embodiments, the release lever 1608 is between 0.5-23 inches. In some embodiments, the release lever 1608 is a different length. Further, the release lever 1608 may have a different design than the curved handle shown.

In an example embodiment, the connector 1600 is used to connect an attachment, such as a cup holder, to an off-road vehicle. The cup holder may be secured between the backing plate 1612 and the release plate 1610. The locking plate 1614 can be inserted through an opening attached to a door panel of a vehicle. The opening may be a square hole that is slightly bigger than the locking plate 1614, as is used in a MOLLE panel. Once inserted, the connector 1600 can be rotated to contact an edge of the inner ring of the locking panel 1614 against an edge of the MOLLE panel. Then, the protrusion 1618 may be inserted into a corner of the MOLLE panel to further lock the connector 1600 in place. The cup holder is then secured within the vehicle. If the cup holder needs to be removed, the release lever 1608 can be used to release the protrusion 1618 from the corner of the MOLLE panel, then rotate the connector 1600 free. The locking plate 1614 can be withdrawn from the MOLLE panel after rotation.

In some examples, the connector 300, 1300, 1600 is formed integrally with an accessory 200. In such examples, the accessory 200 and the connector 300, 1300, 1600 may be molded as a single part. In some examples, the backing plate 500, 1500, 1612 may be integrally formed as part of a sidewall of the accessory 200 with the locking plate 400, 1400, 1614 being formed as a separate structure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A connector assembly comprising:
a locking plate comprising a plate portion with a first side and a second side, and an inner ring portion, the inner ring portion extending from the locking plate, the inner ring portion comprising a sharp hard edge, a rounded soft edge, a projection, a first recess, and a central hole; and
a backing plate comprising a plate portion with a central hole extending through the plate portion, and a first elevation extending from the plate portion, wherein the first elevation of the backing plate extends into the first recess of the locking plate, and the locking plate is rotatably fixed with respect to the backing plate.

2. The connector assembly of claim 1, wherein the plate portion of the backing plate and the plate portion of the locking plate are parallel.

3. The connector assembly of claim 1, further comprising a bolt extending through the central hole of the backing plate and the central hole of the locking plate.

4. The connector assembly of claim 1, wherein the first side of the locking plate extends at an angle with respect to the first side of the backing plate.

5. The connector assembly of claim 1, wherein the second side of the locking plate extends at an angle with respect to the second side of the backing plate.

6. The connector assembly of claim 1, wherein the backing plate comprises a second elevation extending from the plate portion, and wherein the projection of the locking plate extends between the first elevation and the second elevation.

7. The connector assembly of claim 1, wherein the locking plate comprises a second recess, wherein the second elevation extends into the second recess.

8. An accessory attachment assembly comprising:
an attachment panel;
an accessory; and
a connector, the connector comprising a locking plate and a backing plate, the locking plate arranged at a first side of the accessory and the backing plate arranged at a second side of the accessory, the connector being rotatably adjustable to cause the accessory to be moved between a locked position and an unlocked position with respect to the attachment panel;
wherein the connector comprises a hard edge and a soft edge, wherein the accessory is moved between the locked position and the unlocked position by rotating the soft edge through an interference fit with the attachment panel.

9. The accessory attachment assembly of claim 8, wherein the connector comprises a hard edge and a soft edge, wherein the accessory is moved between the locked position and the unlocked position by rotating the soft edge through an interference fit with the attachment panel.

10. The accessory attachment assembly of claim 8, wherein the hard edge prevents the accessory from being rotated out of the locked position.

11. The accessory attachment assembly of claim 8, wherein, when placed into the locked position, the locking plate is arranged on a first side of the attachment panel and the backing plate is arranged on a second side of the attachment panel.

12. The accessory attachment assembly of claim 8, wherein, when placed into the locked position, the locking plate contacts the attachment panel, and wherein the locking plate comprises a projection that extends through the accessory.

13. The accessory attachment assembly of claim 8, wherein at least a portion of the connector is formed integrally with the accessory.

14. The accessory attachment assembly of claim 8, wherein the backing plate comprises an elevation that extends through the accessory.

15. The accessory attachment assembly of claim 8, further comprising a bolt that extends through the backing plate, the accessory, and the locking plate.

16. The accessory attachment assembly of claim 8, wherein the attachment panel comprises an opening through which the connector extends.

17. The accessory attachment assembly of claim 8, wherein the connector is rotatably fixed to the accessory.

18. A connector assembly comprising:
a locking plate comprising an inner ring portion, the inner ring portion extending from the locking plate, the inner ring portion including one or more sharp hard edges, one or more rounded soft edges, one or more sides between the one or more sharp hard edges and the one or more soft edges that define an outer portion of the inner ring portion, one or more projections within the inner ring portion, a first recess, and a central hole;
a backing plate comprising a first plate portion with a central hole extending through the first plate portion, and a first elevation extending from the first plate portion; and
a release plate comprising a second plate portion with a central hole extending through the second plate portion, a second elevation extending from the plate portion, a release lever with a protrusion, and a second recess, the release lever configured to insert the protrusion into an aperture to lock the release plate and locking plate in a locked position, and further configured to retract the protrusion from the aperture to release the release plate and the locking plate from the locked position;
wherein the first elevation of the backing plate extends into the second recess of the release plate, the second elevation extends into the first recess of the locking plate.

19. The connector assembly of claim 18, wherein the locking plate, the backing plate, and the rotating plate are rotatably fixed with respect to each other.

20. The connector assembly of claim 18, further comprising a bolt extending through the central hole of the backing plate, the central hole of the locking plate, and the central hole of the release plate.
